(19) United States
(12) Patent Application Publication
(10) Pub. No.: US 2009/0055437 A1
(43) Pub. Date: Feb. 26, 2009

(54) REFERENT TRACKING OF PORTIONS OF REALITY

(75) Inventors: Werner M.R. Ceusters, Buffalo, NY (US); Shahid Manzoor, Amherst, NY (US); Barry Smith, Williamsville, NY (US)

Correspondence Address: HESLIN ROTHENBERG FARLEY & MESITI PC, 5 COLUMBIA CIRCLE, ALBANY, NY, 12203, US

(73) Assignee: THE RESEARCH FOUNDATION OF SUNY, Amherst, NY (US)

(21) Appl. No.: 12/187,149

(22) Filed: Aug. 6, 2008

Related U.S. Application Data
(60) Provisional application No. 60/963,736, filed on Aug. 7, 2007.

(51) Int. Cl. G06F 17/00

(52) U.S. Cl. 707/104.1; 707/E17.005

(57) ABSTRACT

Management of information is facilitated by unambiguously tracking portions of reality over time. To track the portions of reality, a referent tracking system is used. The referent tracking system is able to communicate with other tracking systems and/or tradition information systems. Errors in the referent tracking system are detected and corrected to maintain actual representations of the portions of reality.

### CROSS-REFERENCE TO RELATED APPLICATIONS

This application claims priority to U.S. Provisional Application No. 60/963,736, entitled “Referent Tracking”, filed Aug. 7, 2007, which is hereby incorporated herein by reference in its entirety.

### TECHNICAL FIELD

This invention relates, in general, to referent tracking, and in particular, to employing referent tracking to unambiguously track portions of reality over time.

### BACKGROUND OF THE INVENTION

Today, information is maintained-in information systems which consist of data repositories that contain data in either unstructured form (such as free text or digital multi-media objects) or structured form, the latter being such that numerical information is expressed by means of numbers, and non-numerical information by means of concepts taken from different sorts of terminologies (such as vocabularies, nomenclatures, concept systems, and so forth) as they are offered in terminology servers. However, current information systems do not offer a mechanism to unambiguously determine in each individual case what entity in reality a concept from a terminology server is used to relate to. As a consequence, information systems thus conceived work with instances of data, but algorithms working on such data have no clue what the data are about, i.e. about what specific entity in reality each specific data-element contains the information.

For example, if a driving license number is used in an information system, it is often not formally clear whether the number is used to denote the driving license of a person or that person itself.

As a further example, if in an information system the gender of a person is stated to be “unknown”, then it is often not formally clear whether this means either (1) that the person does have a gender which is one of the scientifically known gender types, such as female, male, mosaic, etc., but that information of the precise gender of that person is not available in that information system, or (2) that the gender of that person is known to be of a type which scientifically has not yet been determined.

Another example is that if at a certain time the gender of a specific person is stated in some information system as being “male”, and at a later time it is stated to be “female”, then there is, under existing data storage paradigms, no way to derive from this change whether the change in the information system reflects (1) a change in reality, for instance, because the person underwent transgender surgery, (2) a change in what became known about reality: the person's gender might because of a congenital disorder not have been determinable at the time of birth, but only later after several investigations, or (3) that there was no change in reality or what we know about it, but that at the time of the first entry a simple mistake was made. One can even imagine a fourth possibility, namely that the meaning of the word “female” would have been changed.

These problems of inadequate reference are particularly, although by far not exclusively, relevant in Electronic Health Record systems (EHRs). EHRs consist primarily of descriptions of a patient's medical condition, the treatments administered, and the outcomes obtained. These descriptions are about concrete entities in reality, such as the particular pain that the patient experienced in his chest on this specific day; or about the particular pacemaker that was implanted. The descriptions contained in current EHRs include very few explicit references to such entities, but primarily expressions in generic terms that are either in natural language or taken from terminologies or ontologies.

This has some obvious consequences. When a patient suffers from the same type of disease and exhibits the same kinds of symptoms on two successive occasions, then the descriptions of these conditions using concept-codes from a terminology will be identical. When another patient suffers from the same type of disease and exhibits similar symptoms in his turn, then the resulting descriptions will also be identical to those relating to the first patient. But note that one cannot assume that if the same code is used in two such records, then they refer to two distinct entities. When a fracture code is used in relation to two distinct patients, then numerically different fractures are involved. But when a code is used to provide the additional information that the fractures are due to an accident in a swimming pool, the very same, probably dangerous, swimming pool might be involved.

One also cannot assume that if two different concept-codes are used in an EHR, then they refer to different entities. It may be that the most specific or detailed code is not always used when the same entity is referred to on successive occasions. A colon polyp might simply be referred to as “intestinal polyp”, or just “polyp”, and thus associated on successive occasions with different codes. It might also be that the polyp has become malignant, and then it might be assigned the code for malignant neoplasm of colon. Clearly, the relevant entity, i.e. the polyp, underwent changes. But it is still the same entity: its identity did not change. A third reason why different general codes may not automatically be taken to refer to different particular instances turns on the fact that a concept-code may not suffice to describe a given instance appropriately. If, for example, one wants to use SNOMED-CT (v0301) to code a closed pedicular fracture of the fifth cervical vertebra, then a single code is not available; to give a faithful description one must combine several codes. If, however, these codes are not entered in the EHR in such a way that it is clear that they refer to the same particular entity, then their presence might be taken incorrectly to refer to two different fractures.

### SUMMARY OF THE INVENTION

Based on the foregoing, a need exists for an enhanced information system. In particular, a need exists for a referent tracking system that enables the unambiguous tracking of specific aspects of reality. For example, a capability is needed for tracking entities (in reality), their relationships and descriptions thereof over time. A further need exists for a capability to detect and correct errors in a referent tracking system. Yet, a further need exists for a capability that enables a referent tracking system to communicate with other referent tracking systems and/or traditional systems. Moreover, a need exists for a capability that enables translation of data collected by traditional information systems into a format that satisfies the data organization scheme of a referent tracking system.

The shortcomings of the prior art are overcome and additional advantages are provided through the provision of a method of facilitating the management of information. The method includes, for instance, providing in a tracking system a description of a portion of reality to be tracked, the portion of reality being a specific part of reality to be tracked by the tracking system, the description including, for instance, a plurality of entities that represent items that exist or have existed in reality and that are relevant to the specific portion of reality to be tracked; a first data type assigned to the plurality of entities; information about one or more configurations, wherein a configuration of the one or more configurations is an association between two or more entities of the plurality of entities; and a second data type assigned to one or more types of the one or more configurations, the second data type being different from the first data type and explicitly distinguishing configurations from entities; and using the description to unambiguously track the portion of reality over a selected time period.

Systems and computer program products relating to one or more aspects of the present invention are also described and claimed herein.

Additional features and advantages are realized through the techniques of the present invention. Other embodiments and aspects of the invention are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts one embodiment of a referent tracking system, in accordance with an aspect of the present invention;

FIG. 2 depicts one example of a network of referent tracking systems sharing data, in accordance with an aspect of the present invention;

FIG. 3 depicts one example of the elements of a portion of reality and the relationships of those elements, in accordance with an aspect of the present invention;

FIG. 4 depicts one example of a layered architecture of a referent tracking system, in accordance with an aspect of the present invention;

FIG. 5 depicts one embodiment of the logic to assign instance unique identifiers (IUIs), in accordance with an aspect of the present invention;

FIG. 6 depicts one example of a middleware component used in accordance with an aspect of the present invention;

FIG. 7 depicts one embodiment of the logic to correct an error in a referent tracking system, in accordance with an aspect of the present invention; and

FIG. 8 depicts one embodiment of a computer program product incorporating one or more aspects of the present invention.

### DETAILED DESCRIPTION OF THE INVENTION

In accordance with an aspect of the present invention, a capability is provided to facilitate the management of information. As one example, portions of reality, described below, are unambiguously tracked over time. In particular, entities (of a portion of reality), their relationships and descriptions thereof are tracked. To facilitate the tracking, in one example, a referent tracking system is used.

In a further aspect of the present invention, one referent tracking system is able to communicate with other referent tracking systems and/or traditional information systems. Further, a capability is provided that enables translation of data collected by traditional information systems into a format that satisfies the data organization schema of a referent tracking system.

Yet further, a capability is provided that enables errors in the referent tracking system to be detected and corrected in such a way that after a correction has been introduced, the prior state of knowledge can still be tracked.

Further details of a referent tracking system and the various features of the present invention, including, but not limited to, those mentioned above, are described below.

One aspect of the present invention relates to referents and the management of a specific form of references, called “representational units”, thereof in a Referent Tracking System (RTS), such that the structure in which the references are organized in the RTS serves as a digital copy of the structure of the portion of reality formed by the referents. By “referent”, it is meant an entity in reality, such as a specific person, a specific organization, a football game played at a specific date and place, for which it is the case that there exists another entity in reality called “information bearer”, such as a specific record in an information system that (1) denotes, represents, or carries information about the former, or (2) contains a reference to the former while being about another entity in reality. In addition, one aspect of the invention allows these information bearers themselves to be treated as referents in other information bearers through which they are referenced. As a consequence, an RTS embodies a generic capability that offers at least two functions: (1) to keep track of what is the case in reality, and (2) to keep track in an objective way of what information is stored in information systems about that reality, thus what is known about reality from the perspective of specific information systems and their users.

With respect to the first function, an RTS with appropriate user-interfaces can perform similar functions as currently existing traditional information systems, but because of the specific way in which the references are set up, has the advantage that only the user-interfaces need to be tailored towards the specific needs of its users, but not the underlying data and information models. Thus, although a specific RTS might be set up and used to collect data for a specific purpose, this purpose will not be reflected in the organizational structure of the data, so that the data, in contrast to existing approaches, can be re-used un-problematically for other purposes than those for which they have been collected.

With respect to the second function, an RTS can be used as a device to make traditional information systems semantically interoperable. By “semantic interoperability”, is meant the ability of, for instance, two or more computer systems to exchange information and have the meaning of that information automatically interpreted by the receiving system accurately enough to produce useful results, as defined by the end users of both systems. Current attempts to achieve semantic interoperability rely on agreements about the meaning of so-called concepts stored in terminology-systems, such as nomenclatures, vocabularies, thesauri, or ontologies, the idea being that if all computer systems use the same terminology, they can understand each other perfectly. The reality is, however, that, rather than one such terminology being generally adopted, the number of terminology-systems with mutually incompatible definitions or non-resolvable overlap amongst concepts grows exponentially, thereby contributing more to the problem of semantic non-interoperability than solving it.

Components of a Referent Tracking System

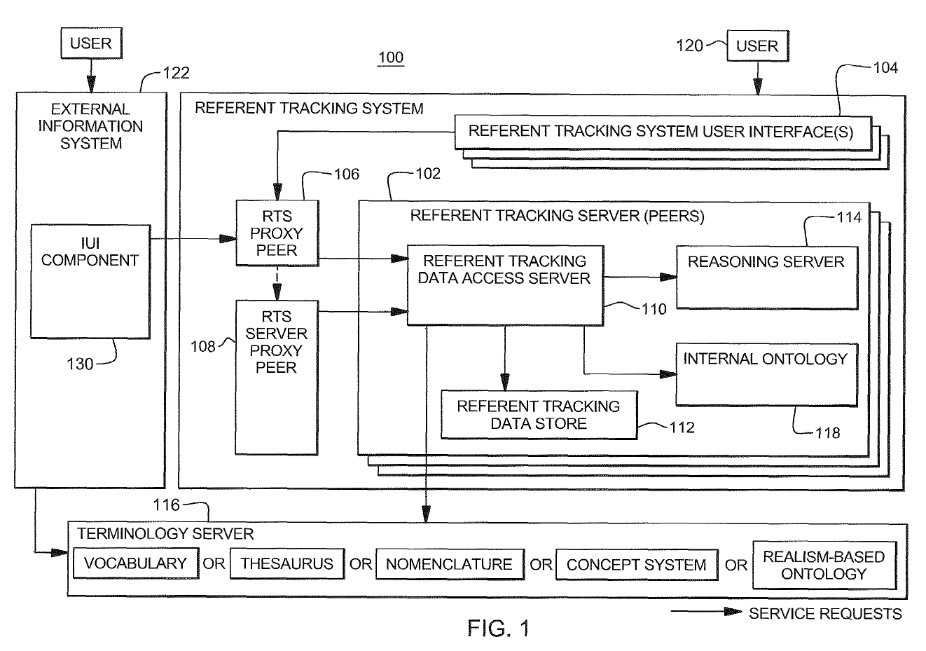

A “referent (a.k.a., reference) tracking system” (RTS) is a special kind of digital information system which keeps track of (1) what is the case in reality and (2) what is expressed in other information systems about what is believed to be the case in reality. One example of a RTS is described with reference to FIG. 1. The direction of the arrows depicted therein shows the processing of service requests. However, the communication is bi-directional to accommodate responses to the requests.

As shown in FIG. 1, in one example, an RTS includes at least four types of components: (1) one or more referent tracking servers 102, (2) one or more referent tracking system user interfaces 104, (3) an RTS Proxy Peer 106, and (4) an RTS Server Proxy Peer 108.

As an example, the components execute on one or more computing units, such as one or more processors, computers or computing devices, which have the following specifications, as one example: Intel® Core 2 Duo e6400 processor (Intel® is a registered trademark of Intel Corporation); RAM 2 GB; Windows® XP Operating System (Windows® is a registered trademark of Microsoft Corporation); and a VGA card and monitor screen supporting a resolution of 1024×768. Although the above specifications are provided as one example, the components can run on many types of processors, computers, computing devices or other computing units having various specifications. The specifications provided are just one example. Further, all of the components of the referent tracking system can run on one computing unit; one or more components can run on one computing unit, while others run on one or more other computing units; or the components may be distributed among various computing units. Many configurations are possible without departing from the sprit of the present invention.

Each referent tracking server includes, for instance, a data access server 110, which manages service requests coming from RTS Proxy Peer 106 or RTS Server Proxy Peer 108 and which performs data manipulation on the server's main component: a referent tracking data store 112 thereby assisted by a reasoning server 114. The latter performs various sorts of reasoning functions by combining data from the data store with information coming from external terminology servers 116. The type of reasoning that can be performed depends on whether the terminology server contains nomenclatures, vocabularies, thesauri, and so forth.

The referent tracking server comes also with an internal ontology 18, which is a repository dedicated, for instance, to store information obtained during the initialization process, access control information about authorized users and usages, and so forth.

The referent tracking system user interfaces allow direct users 120 of the RTS to perform (1) a variety of management functions such as registering new external information systems 122, configuring a referent tracking server, adding additional referent tracking servers, and so forth, and (2) content functions such as running pattern-matching logic on the data in the referent tracking data store to detect inconsistencies, invoke triggers and alerts, perform population-based studies, and so forth.

Networks of Referent Tracking Systems

Since referent tracking is to make reference to entities in reality by means of singular and globally unique identifiers, one set up is one in which only one RTS is used worldwide. More realistically, however, is the adoption of the RT paradigm in a step-wise fashion: each organization first installs its own RTS, and afterwards connects them in expanding networks.

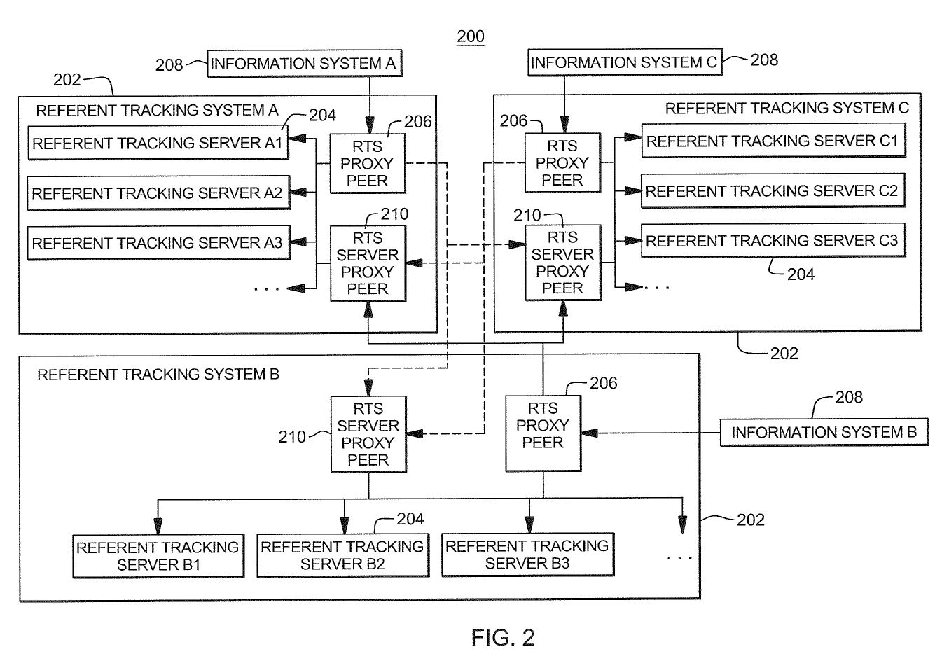

To support this evolution, as shown in FIG. 2, the RTS is built upon Peer to Peer (P2P) technology, enabling data sharing in such a way that a search query can be executed concurrently over distributed RTS servers (peers). In an RTS P2P network, a client thus sends a query to an RTS server which besides executing the query itself can forward it to other connected RTS servers for subsequent execution. Each peer then collects the results and sends them to the requesting peer. Finally, the RTS server who received the initial request returns the aggregated results to the client. Furthermore, an RTS P2P application is capable of database load sharing over multiple RTS server peers such that the network behaves as a singular database. This capability is useful in cases where a very large database cannot be hosted on a single machine, for instance because of computational limits. Furthermore, one or more aspects of the present invention includes capabilities for discovering a new peer in a network, for authenticating users, and for ensuring secure communication.

In one example, the application design is a mix of client-server and P2P programming models. As an embodiment, a RTS P2P network 200 (FIG. 2) includes, for instance, a plurality of RT systems 202, each of which includes several RTS peers of three distinct types: (1) RTS Server Peers 204 that only execute the queries (as a central server) received from other network peers, (2) Proxy Peers 206 which function as clients of Server Peers and which provide interfaces to external information systems (clients) 208, and (3) Server Proxy Peers 210 that act as a combination of Server Peers and Proxy Peers by first accepting and executing query requests from other Proxy Peers and then forwarding the queries to other Server Peers. The RTS clients, external information systems, just call the application programming interface methods of their Proxy Peer to send a query, which forwards the query to the connected RTS Server Peers.

An example of an RTS network is shown in FIG. 2, in which three organizations, A, B and C, are running their own RTS peers 204. The peers are installed in such a way that they are not directly known outside their corresponding health care institute's environment. In organization A, the Server Peers are alike in all respects and implement the objective of distributing a very large database load. When Information System A sends a search query to the RTS Proxy Peer within organization A, the latter forwards the query to all available Server Peers (A1, A2, . . .) in the organization which concurrently execute the query and return the results to the Proxy Peer that finally sends the results to the Information System.

Each organization can form its own local group of servers whose membership is not known outside the organization, which protects against unauthorized access to the peers in the group. Controlled “public” access to each organization's data is offered through the Proxy Server peers. The separation of local peer advertisement within an organization from public (outside the host organization) contexts is the basis for the implemented security layer. The peers which are known locally provide full access to the local database, and the peers which are known publicly provide very restricted access to the database (they might, for instance, allow only searches over certain sorts of RT tuples, as explained further).

Reality, Data and Aboutness

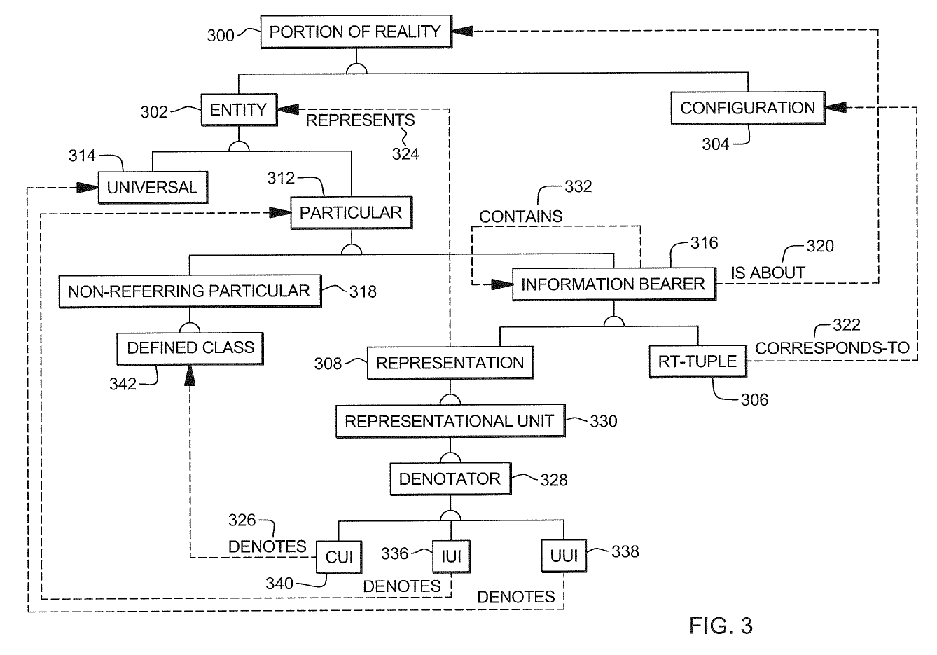

A referent tracking system is distinct from other information systems in that each data element points to a portion of reality in a specific way. This is described further with reference to FIG. 3, which displays the partitioning of reality implied by the ideas upon which referent tracking is built, including the place of data elements as they are encountered in information systems.

In one aspect, a capability (e.g., technique and system) is provided for the unambiguous symbolic representation of portions of reality in a digital information network that includes several representational and computational (e.g., logic, servers, etc.) facilities, as further described herein.

Referring to FIG. 3, by “portion of reality” is meant any individual entity 302 or configuration of entities 304 standing in some relation to each other. By “entity” is meant anything that exists or has existed in the past, whatever its nature. In a healthcare context, examples of entities are a specific person, a specific disorder in that person, a specific diagnosis made by a specific physician about that disorder, a specific treatment for that person initiated by another physician on a specific date in response to that diagnosis, etc.

A “configuration” is a portion of reality which is not an entity in its own right. Whereas a specific patient, its specific disorder, the physician examining the patient, and the examination itself are each individual entities, the configuration that this disorder is inside that patient, that the physician is examining that patient, etc, is not. Another example of a configuration is the being of a person in a car. Both that car and that person are entities, but the fact that that person is in that car, is not. If that engine would not be in the car, but, for instance be placed by a mechanic outside the car for repair purposes, still the very same entities (the car and the engine) would be involved, but there would be another configuration.

A representational facility of the capability is that through the data types that it comprises, it makes the distinction between configurations and entities explicitly, as shown in FIG. 3.

Configurations are referred to by means of a data type referred to as a “RT-tuple” 306, whereas entities are represented by means of a data type called “representation” 308. Both data types come in several forms depending on the nature of the portion of reality they carry information about.

Another representational facility is that, through its data types, it allows for the drawing of an explicit distinction between specific entities (called “particulars” 312) from generic entities (called “universals” 314).

Particulars are specific and unique entities, unique in the sense that they each occupy specific regions of space and time, and that nothing else than a specific particular can be that particular. Examples are concrete persons, such as George W. Bush Jr. and George W. Bush's heart. Some particulars, such as each of six chairs around a specific dining table, may exactly look the same, but they are still distinct particulars. One can be destroyed, while the other five remain intact. For particulars of specific interest, such as persons, ships, and hurricanes, proper names are used to mark the importance of their individual identity. For other particulars, such as cars or pieces of medical equipment, serial numbers are used for unique identification purposes.

Universals, in contrast, are such that they are (1) generic and (2) expressed in language by means of general terms, such as ‘person’, ‘ship’, and ‘car’, and (3) represent structures or characteristics in reality which are exemplified in an open-ended collection of particulars in arbitrarily disconnected regions of space and time.

Another representational facility is that, through its data types, it makes explicitly the distinction between two sorts of particulars: those that are information bearers 316, and those that are not; the latter called non-referring particulars 318. Examples of information bearers are a piece of paper containing a text about a person's medical history, and a digital object, such as an image of a person in an information system. Information bearers are “about” something else, while non-referring particulars are not about something else. Information bearers can be about not only non-referring particulars, an example being the driving license card of a person which is about its driving rights, but also about other information bearers, an example being a textual description of a specific person's driving license, stating, for instance, that the name of the driver is almost not readable. A copy of such a driving license can be at the same time about both the card and the rights enjoyed by the license holder.

Another representational facility is that it distinguishes explicitly and formally between various relations that obtain (are held) between the various types of portions of reality it is capable of describing. These relations are:
“is-about” 320, which obtains between an information bearer and a portion of reality, such as, for example, a book about George W. Bush Sr. (the book being an information bearer) being about parts of the life of George W. Bush Sr. and his environment (a combination of several configurations in which figure, besides George W. Bush Sr., various other entities such as his advisors, friends, trips, speeches, and so forth).
“corresponds-to” 322, which obtains between an RT-tuple and a configuration;
“represents” 324, which obtains between a specific subtype of information bearer, namely called a “representation”, and some further entity (or collection of entities). A representation is thus such that (1) the information it contains is about an entity, and not a configuration, external to the representation and (2) it stands for or represents that entity.

Examples are an image, record, description or map of the United States.

Note that a representation (e.g., a description such as ‘the cat over there on the mat’) represents a given entity even though it leaves out many aspects of its target.
“denotes” 326, which obtains between data-elements expressed by means of a data type called “denotator” 328 and an entity. A denotator is a representational unit 330 which denotes directly an entity in its entirety without providing a description. An example of a denotator is the string “Bush” in the sentence “President Bush visited Europe several times” when, whether or not known to the reader of the sentence in question, the writer had in mind a particular Bush, whether George Bush Jr. or George Bush Sr. The sentence itself is an information bearer according to the terminology used herein. Because many representations are built out of constituent sub-representations as their parts, in the way in which paragraphs are built out of sentences and sentences out of words, an aspect of the invention uses the data type “representational unit” to represent such smallest part. Examples are: icons, names, simple word forms, or the sorts of alphanumeric identifiers found in digital records. Note that many images are not composite representations since they are not built out of smallest representational units in the way in which molecules are built out of atoms. (For example, pixels are not representational units in the sense defined.)
“contains” 332, which obtains between information bearers and can be used to express what pieces of information of a specific data type are parts of other pieces of information. An example is a digital message which contains RT-tuples describing configurations of entities in which a specific person figures.

Another representational facility is that it distinguishes explicitly and formally between three types of denotators, referred to respectively as “IUI” 336, “UUI” 338 and “CUI” 340.

An IUI 336—abbreviation for “Instance Unique Identifier”—is a denotator in the form of a persistent, globally unique and singular identifier which is stored in a referent tracking system and which denotes or is believed to denote a particular. It includes the principles and methods applied in the RTS that assure—modulo the occurrence of errors, the resolution of which is also covered by an aspect of the present invention—that an IUI is (1) persistent because once created in a RTS it is never deleted, (2) globally unique because a IUI denotes only one entity within an RTS, and (3) singular because within an RTS, there is only one IUI for a specific entity.

A UUI 338—abbreviation for “Universal Unique Identifier”—is a denotator which denotes a universal within the context of a realism-based ontology, a specific sort of knowledge resource within a terminology server.

A CUI 340—abbreviation for “Concept Unique Identifier”—is a denotator for what is commonly called a “concept”, but which in the context of a referent tracking system is referred to as a “defined class” 342, and what is defined as a subset of the extension of a universal which is such that the members of this subset exhibit an additional property which is (a) not shared by all instances of the universal, and (b) also (might be) exhibited by particulars which are not instances of that universal.

Another representational facility is that, because of (1) the explicit distinction between information bearers and other entities, and between various sorts of non-referring entities, and (2) the specific way in which the RT-tuples are defined, the structure of the internal representation inside the system mimics the external structure of reality which offers thus a measure for the quality of the representation. The appropriateness of this measure rests on three axioms. The first one is that reality exists objectively in and of itself, i.e. independently of the perceptions or beliefs or theories of cognitive beings. Thus, that not only do a wide variety of entities exist in reality (human beings, hearts, bacteria, disorders, . . . ), but so also the relations between these entities (that certain hearts are parts of human beings, that certain bacteria cause disorders in human beings) is not a matter of agreements made by scientists, but rather of objective fact. The second assumption is that reality is accessible to us and that its structure can be discovered: scientific research allows human beings to establish what entities exist and what relationships obtain between them. The third assumption is that information in information systems and terminology servers should as far as possible mirror the corresponding domain of reality. Thus, an important aspect of the quality of an information system is determined by the degree to which (1) its individual representational units correspond to entities in reality, and (2) the structure according to which these units are organized mimics the corresponding structure of reality.

A Use Case Scenario: A Patient with an Adverse Event

Table 1 below shows some adverse event definitions from various sources.

TABLE 1

| ID | Term | Definition |
|---|---|---|
| D1 | adverse drug | Any incident in which the use of a medication (drug or biologic) at any dose, a |
| | event | medical device, or a special nutritional product (for example, dietary |
| | (adverse drug | supplement, infant formula, medical food) may have resulted in an adverse |
| | error) | outcome in a patient. |
| D2 | adverse drug | any adverse event associated with the use of a drug in humans, whether or not |
| | experience | considered drug related, including the following: |
| | | an adverse event occurring in the course of the use of a drug product in |
| | | professional practice; |
| | | an adverse event occurring from drug overdose whether accidental or |
| | | intentional; |
| | | an adverse event occurring from drug abuse; |
| | | an adverse event occurring from drug withdrawal; and |
| | | any failure of expected pharmacological action. |
| D3 | adverse drug | an undesirable response associated with use of a drug that either compromises |
| | reaction | therapeutic efficacy, enhances toxicity, or both. |
| D4 | adverse event | an observation of a change in the state of a subject assessed as being untoward |
| | | by one or more interested parties within the context of a protocol-driven |
| | | research or public health. |
| D5 | adverse event | an event that results in unintended harm to the patient by an act of commission |
| | | or omission rather than by the underlying disease or condition of the patient |
| D6 | adverse event | any unfavourable and unintended sign (including an abnormal laboratory |
| | | finding), symptom, or disease temporally associated with the use of a medical |
| | | treatment or procedure that may or may not be considered related to the medical |
| | | treatment or procedure |
| D7 | adverse event | any untoward medical occurrence in a patient or clinical investigation subject |
| | | administered a pharmaceutical product and which does not necessarily have to |
| | | have a causal relationship with this treatment |
| D8 | adverse event | an untoward, undesirable, and usually unanticipated event, such as death of a |
| | | patient, an employee, or a visitor in a health care organization. Incidents such as |
| | | patient falls or improper administration of medications are also considered |
| | | adverse events even if there is no permanent effect on the patient. |
| D9 | adverse event | an injury that was caused by medical management and that results in |
| | | measurable disability. |

Table 2 below shows the minimal collection of representations related to entities in reality that are to be taken into consideration to be in a position to represent the portion of reality around a particular patient as an adverse event. Under the label ‘Denotation’, a generic term is provided that is applicable to a member of the corresponding class. The ‘Class type’ column indicates whether the class is the extension of a universal (U) or a defined class (DC). The ‘Particular type’ column indicates to what category of particulars, the members of the corresponding class belong.

The descriptions provided in the right-most column illustrate the sorts of roles played by different sorts of entities in a scenario in which an adverse event might have occurred. The conditionals that are used in most of these descriptions reflect the fact that a particular portion of reality might be such that a phenomenon which is considered to be an adverse event under one definition, is not an adverse event in terms of another definition. The conditionals should not be interpreted as having in every case to do with probabilities or uncertainty.

TABLE 2
Universals and Defined Classes for the Adverse Events Domain.

| | | Class | Particular | |
|---|---|---|---|---|
| | Denotation | Type | Type | Description (role in adverse event scenario) |
| C1 | subject of | DC | independent | person to whom harm might have been done through an act |
| | care | | continuant | under scrutiny |
| C2 | act under | DC | act of care | act of care that might have caused harm to the subject of |
| | scrutiny | | | care |
| C3 | act of care | U | process | activity carried out by a care giver to a subject of care, |
| | | | | motivated by an underlying disease and a care intention |
| C4 | care giver | DC | independent | person that performed an act of care directed to the subject |
| | | | continuant | of care |
| C5 | underlying | DC | dependent | the disease in the subject of care which is part of what |
| | disease | | continuant | serves to motivate performance of the act of care |
| C6 | involved | DC | independent | anatomical structure (of the subject of care) involved in an |
| | structure | | continuant | act of care |
| C7 | structure | U | process | change in an anatomical structure of a person |
| | change | | | |
| C8 | structure | U | dependent | aspect of an anatomical structure deviation from which |
| | integrity | | continuant | would bring it about that the anatomical structure would |
| | | | | either (1) itself become dysfunctional or (2) cause |
| | | | | dysfunction in another anatomical structure |
| C9 | integrity | U | structure | change in the structure integrity bringing about a change in |
| | change | | change | the range of circumstances under which the anatomical |
| | | | | structure would become dysfunctional or cause dysfunction |
| | | | | in another structure |
| C10 | harm | U | integrity | integrity change bringing about an expansion in the range |
| | | | change | of circumstances of the sort typically occurring in the life of |
| | | | | the subject of care under which the anatomical structure |
| | | | | would become dysfunctional or cause dysfunction in |
| | | | | another structure |
| C11 | care effect | DC | integrity | integrity change brought about by an act of care |
| | | | change | |
| C12 | subject | DC | process | looking for a structure change in the subject of care |
| | investigation | | | |
| C13 | harm | U | process | determining whether an observation is faithful to reality, |
| | assessment | | | and if so, whether the structure change which is the target |
| | | | | of the observation is a harm |
| C14 | care | DC | dependent | intention of a care giver that motivates him towards an act |
| | intention | | continuant | of care |
| C15 | observation | DC | dependent | cognitive representation of a structure change resulting |
| | | | continuant | from an act of perception within a subject investigation |
| C16 | harm | DC | dependent | cognitive representation, resulting from a harm |
| | diagnosis | | continuant | assessment, and involving an assertion to the effect that a |
| | | | | structure change is or is not a harm |
| C17 | care effect | DC | dependent | belief on the side of the care giver concerning the care |
| | belief | | continuant | effect that he ascribes to the act of care |
| C18 | care | DC | information | concretized (through text, diagram, . . . ) piece of |
| | reference | | entity | knowledge drawn from state of the art principles that can be |
| | | | | used to support the appropriateness of (or correctness with |
| | | | | which) processes are performed involving a subject of care |

The representational units for the core classes identified above can be used to represent all possible portions of reality which feature entities that can be referred to by means of the term 'adverse event’ under any of the definitions in Table 1 above. As an example, Table 3 below lists the particulars and associated properties involved in a case in which:
A patient born at time t₀;
Undergoing anti-inflammatory treatment and physiotherapy since t₂;
For an arthrosis present since t₁;
Develops a stomach ulcer at t₃.

This table thereby provides an example of an adverse event case analysis of the sort that is made possible by the framework here presented.

The relationships employed in composing representations of properties in this Table are drawn from realism-based ontology. The primitive is_about relation is introduced, which holds between a representational unit and the entity in reality about which this unit contains information at a certain time. Certain shortcuts are taken in the representation of the temporal relationships involved in such an analysis, by simply stating for example that to earlier t₁ earlier t₂ earlier t₃.

TABLE 3
Example of an Adverse Event Case Analysis

| IUI | Particular description | Properties |
|---|---|---|
| #1 | the patient who is treated | #1 member C1 since t₂ |
| #2 | #1's treatment | #2 instance_of C3 |
| | | #2 has_participant #1 since t₂ |
| | | #2 has_agent #3 since t₂ |
| #3 | the physician responsible for #2 | #3 member C4 since t₂ |
| #4 | #1's arthrosis | #4 member C5 since t₁ |
| #5 | #1's anti-inflammatory treatment | #5 part_of #2 |
| | | #5 member C2 since t₃ |
| #6 | #1's physiotherapy | #6 part_of #2 |
| #7 | #1's stomach | #7 member C6 since t₂ |
| #8 | #7's structure integrity | #8 instance_of C8 since t₀ |
| | | #8 inheres_in #7 since t₀ |
| #9 | #1's stomach ulcer | #9 part_of #7 since t₃ |
| #10 | coming into existence of #9 | #10 has_participant #9 at t₃ |
| #11 | change brought about by #9 | #11 has_agent #9 since t₃ |
| | | #11 has_participant #8 since t₃ |
| | | #11 instance_of C10 at t₃ |
| #12 | noticing the presence of #9 | #12 has_participant #9 at t₃₊ₓ |
| | | #12 has_agent #3 at t₃₊ₓ |
| #13 | cognitive representation in #3 | #13 is _about #9 since t₃₊ₓ |
| | about #9 | |

Under the proposed scenario, #10, i.e. the coming into existence of #9, would (modulo the wide variation in interpretations that can be given to the majority of the definitions found) qualify as an adverse event as defined in D5 of Table 1 above. However, for definition D9, it would rather be #9 itself that would so qualify, while for D4, it would be either #12 or #13.

Referent Tracking Data Elements: RT-Tuples

Information in an RTS is stored by means of tuples, called “RT-tuples”, which come in various flavors depending on the sort of information they contain.

A-Tuples

When, after due consideration, a particular has been identified as requiring a IUI, then an alphanumeric string, thus far unused, is generated by a unique ID generator and an act of assignment is carried out. At least one example of this generation and assignment is described in Ceusters W, Smith B. Referent Tracking for Digital Rights Management. International Journal of Metadata, Semantics and Ontologies 2007;2(1):45-53; Ceusters W, Smith B. Referent Tracking and its Applications. In: Proceedings of the WWW2007 Workshop i3: Identity, Identifiers, Identification. Banff, Canada, May 8, 2007, CEUR Workshop Proceedings, ISSN 1613-0073, online http://ceur-ws.org/Vol-249/submission_{—}105.pdf; Rudnicki R, Ceusters W, Manzoor S, Smith B. What Particulars are Referred to in EHR Data? A Case Study in Integrating Referent Tracking into an Electronic Health Record Application. In Teich J M, Suermondt J, Hripcsak C. (eds.), American Medical Informatics Association 2007 Annual Symposium Proceedings, Biomedical and Health Informatics: From Foundations to Applications to Policy, Chicago Ill., 2007;:630-634; and Manzoor S, Ceusters W, Rudnicki R. A Middleware Approach to Integrate Referent Tracking in EHR Systems. In Teich J M, Suermondt J, Hripcsak C. (eds.), American Medical Informatics Association 2007 Annual Symposium Proceedings, Biomedical and Health Informatics: From Foundations to Applications to Policy, Chicago Ill., 2007;:503-507, each of which is hereby incorporated herein by reference in its entirety.

An IUI is created out of the generated string, by attaching it to the particular in question. Three factors can be distinguished as structural elements involved in such an assignment act:
1. The generation of the relevant alphanumeric string;
2. Its attachment to the relevant object;
3. The publication of this attachment.

The resulting IUIs will, together with certain further types of associated information, constitute the IUI-repository.

The units, called “A-tuples” that are deposited in this repository and that represent the assignment act (‘A’, here, stands for assignment) are, in one example, of the form:
<IUIₚ, IUIₐ, tₐₚ>

where IUIₚ is the IUI of the particular in question, IUIₐ is the IUI of the author of the assignment act, and tₐₚ is a time-stamp indicating when the assignment was made.

D-Tuples

In light of the need or desire to resolve mistakes, one aspect of the invention includes the use of meta-data called “D-tuples”. D-tuples are created whenever (1) a tuple other than a D-tuple is added to the RTS Data Store, in which case it includes meta-data about by whom and at what time the corresponding tuple was deposited, or (2) a tuple, including D-tuples, is declared invalid in the system, in which case it includes additional information concerning the type of mistake committed and the reason therefor.

D-tuples are, for instance, of the form:
<IUI_{d}, IUI_{A}, t_{d}, E, C, S >

where:
IUI_{A}: The IUI of the corresponding A-tuple;
IUI_{d}: The IUI of the entity annotating IUI_{A} by means of this D-tuple;
E: Either the symbol ‘I’ (for insertion) or any of the error type symbols as discussed further;
C: A symbol for the applicable reason for change as discussed further;
t_{d}: The time the tuple denoted by IUI_{A} is inserted or ‘retired’; and
S: A list of IUIs denoting the tuples, if any, that replace the retired one.

PtoP-Tuples

Descriptions which express configurations amongst particulars are referred to as PtoP—particular to particular—descriptions. Here again a number of structural elements can be distinguished:
1. An authorized user observes one or more objects which have already been assigned IUIs in the referent tracking system (RTS) in hand;
2. The user recognizes or apprehends that these objects stand in a certain relation, which is represented in some realism-based ontology o;
3. The user asserts that this relation holds and publishes this assertion by entering corresponding data which are then published in the referent tracking data store.

This relationship data will then take the form of an ordered sextuple, such as, for example:
<IUIₐ, tₐ, r, IUIₒ, P, tᵣ>

where
IUIₐ is the IUI of the author asserting that the relationship referred to by r holds between the particulars referred to by the IUIs listed in P;
tₐ is a time-stamp indicating when the assertion was made;
r is the denotator in IUIₒ of the relationship obtaining between the particulars referred to in P;
IUIₒ is the IUI of the ontology from which r is taken;
P is an ordered list of IUIs referring to the particulars between which r obtains; and
tᵣ is a time-stamp representing the time at which the relationship was observed to obtain.

P contains as many IUIs as are required by the arity of the relation r. In most cases, P will be an ordered pair which is such that r obtains between the particulars represented by its first and second IUIs when taken in this order.

PtoU-Tuples

Another type of information that can be provided about a particular concerns what universal within an ontology it instantiates. Here, too, time is relevant, since a particular, through development, growth or other changes, may cease to instantiate one universal and start to instantiate another: thus George W. Bush Sr. changed from foetus to newborn, and from child to adult.

Descriptions of this type (which are referred to as PtoUtuples—for: particular to universal) are represented by ordered tuples of, for instance, the form:
<IUIₐ, tₐ, inst, IUIₒ, IUIₚ, UUI, tᵣ>

where
IUIₐ is the IUI of the author asserting that IUIₚ is an instance (inst) of UUI;
tₐ is a time-stamp indicating when the assertion was made;
inst is the denotator in IUIₒ of the relationship of instantiation;
IUIₒ is the IUI of the realism-based ontology from which inst and UUI are taken;
IUIₚ is the IUI referring to the particular whose inst relationship with the universal denoted by UUI is asserted;
UUI is the denotator of the universal in IUIₒ with which IUIₚ enjoys the inst relationship; and
tᵣ is a time-stamp representing the time at which the relationship was observed to obtain.

Note that it is specified from which ontology inst and UUI are taken (and precisely which inst relationship in those cases where an ontology contains several variants). Such specifications not only ensure that the corresponding definitions can be accessed automatically, but also facilitate reasoning in the RTS Reasoning Server across ontologies that are interoperable with the ontology specified.

PtoC-Tuples

Whereas for PtoU-tuples their denotators of relationships and universals are taken from realism-based ontologies rather than from other knowledge repositories in terminology servers, PtoC tuples do allow CUIs to be used instead of UUIs. Of course, the relationship to be used is not to be some variant of ‘inst’ since the standard definitions in use for ‘concept’ (such as ‘unit of knowledge’ or ‘unit of thought’) disallow most particulars from being declared as instances of concepts.

PtoC tuples (for particular to concept code) have the form
<IUIₐ, t₁ₐ, IUI_{c}, IUIₚ, CUI, tᵣ>

where
IUIₐ is the IUI of the author asserting that terms associated to CUI may be used to describe IUIₚ;
tₐ is a time-stamp indicating when the assertion was made;
IUI_{c} is the IUI of the concept-based system from which CUI is taken;
IUIₚ is the IUI referring to the particular which the author associates with CUI;
CUI is the CUI in the concept-system referred to by IUI_{c} which the author associates with IUIₚ; and
tᵣ is a time-stamp representing a time at which the author considers the association appropriate.

Such tuples are to be interpreted as providing a facility equivalent to a simple index of terms in a work of scientific literature.

PtoU(−)-Tuples

Since in one aspect of the invention only entities that exist or have existed are to be assigned an IUI, a capability is provided that deals with what is called ‘negative findings’ or ‘negative observations’ as captured in expressions such as: “no history of diabetes”, “hypertension ruled out”, “absence of metastases in the lung”, and “abortion was prevented”. Such statements seem at first sight to present a problem for the referent tracking paradigm, since they imply that there are no entities in reality to which appropriate unique identifiers could be assigned.

Therefore, the following relationship is defined: p lacks u with respect to r at time t: there obtains a relation between the particular p and the universal u at time t, which is such that p stands to no instance of u in the relationship r at t.

This ontological relation can be expressed by means of a “PtoU(—) tuple” which is a lacks-counterpart of the PtoU-tuple and has the following form, in one example:
<IUIₐ, tₐ, r, IUIₒ, IUIₚ, UUI, tᵣ>

It expresses that the particular referred to by IUIₐ asserts at time tₐ that the relation r of ontology IUIₒ does not obtain at time tᵣ between the particular referred to by IUIₚ and any of the instances of the universal UUI at time tᵣ.

PtoN-tuples

Important particulars, such as persons, ships, hurricanes, and so forth are often given proper names which function as denotators in reality outside the context of a referent tracking system. This sort of information is stored in an RTS by means of one or more “PtoN-tuples” where “N” stands for “name”.

These tuples have the following form, as an example:
<IUIₐ, tₐ, nt, n, IUIₚ, tᵣ, IUI_{c}>

where
IUIₐ is the IUI of the author asserting that n is a name of type nt used by IUI_{c} to denote IUIₚ;
tₐ is a time-stamp indicating when the assertion was made;
IUI_{c} is the IUI for the particular that uses the name n (this can be a person, a community of persons, an organization, an information system, . . . );
IUIₚ is the IUI referring to the particular which the author associates with n;
n is the name which the author associates with IUIₚ;
nt is the nametype (examples being first name, last name, nick name, social security number, and so forth); and
tᵣ is a time-stamp representing a time at which the author considers the association appropriate.

Referent Tracking Data Store

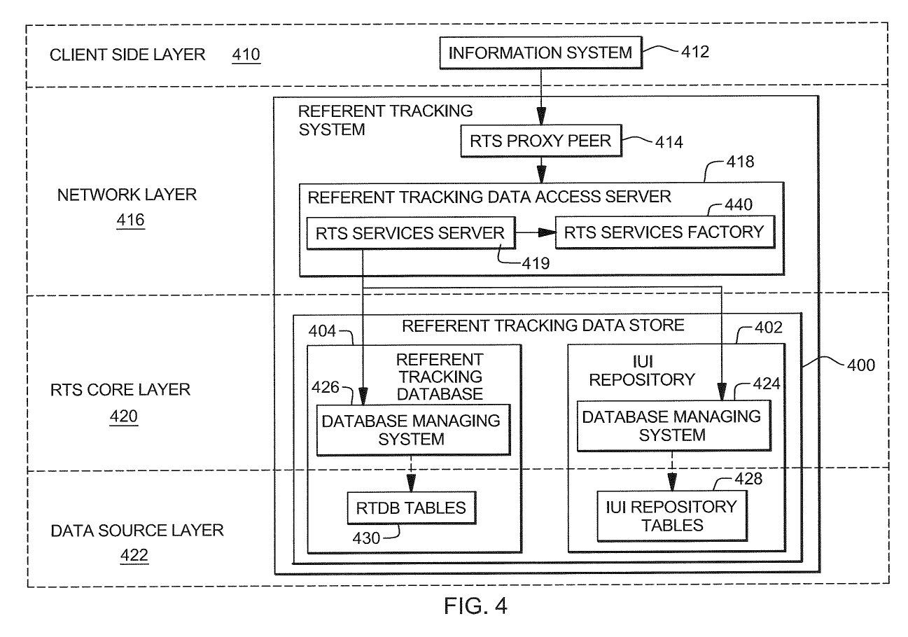

With reference to FIG. 4, further details regarding a referent tracking data store and other aspects of the referent tracking system are described. A referent tracking data store 400 includes, for instance, two parts: an “IUI-repository” 402 and a “referent tracking database” (RTDB) 404. The IUI-repository includes, for instance, the A-tuples and D-tuples. All other tuples are stored in the RTDB, in this example.

In FIG. 4, the application (i.e., RTS) architecture is schematized to be composed of several component layers, where arrows indicate the direction of the information flow. This schematic is further described herein.

A Client Side layer 410 includes the RTS Client which is typically a third party information system 412 or middleware components. The latter sends a query to a Proxy Peer 414 in a network layer 416 that forwards the request to the appropriate RTS server in the network. During execution of the query, a RTS server 418 calls the services of a RTS core 420 API to retrieve the results from the Database Management System databases (DBMS) that constitute a data source layer 422.

RTS Core Layer

RTS Core layer 420 implements the business logic of RT, namely, the insertion and retrieval of RT tuples in a database. RTS datastore 400, includes, for instance, two database applications: IUIRepository database 424 and RTDB system 426. The IUIRepository database manages the statements about the assignment of IUIs to particulars, and provides a central repository of IUIs 428 to the RTS. The RTDB is a database of statements representing the detailed information about particulars, examples being ‘#IUI-1 instantiates the universal Person’ and ‘#IUI-1 has the name “John”.’ It provides one or more tables 430.

The IUIRepository and RTDB components are implemented through a series of application programming interfaces (APIs). The IUIRepository includes services to search particular representations and to insert new ones in its corresponding DBMS. Similarly, the RTDB components provide API get methods (e.g., getPtoN, getPtoP, etc.) to search and create methods (e.g., createPtoN, createPtoP, etc.) to insert tuples in its database.

The IUIRepository and RTDB components are implemented independently of any specific DBMS (e.g., MYSQL, HSQL). DBMS support is controlled by DBMS specific driver components, such as for MYSQL and HSQL.

Insertion services

Insertion services allow inserting a new RT tuple into the repository. The RT tuples are inserted in, for instance, a transaction, which is an information unit. As an example, entering a patient's blood pressure could involve a couple of RT statements which could include one or more RT tuples. All tuples in a transaction are guaranteed to be committed in the data store. In case where either a system breaks down (by power failure or other means) or a user aborts the operation (e.g., a user closes/cancels the data entry screen while entering data), no partial information is stored in the data store. This service marks the start of a transaction for a specific session of a user. The RT paradigm does not allow, in this example, any deletion operation in order to be able to always return to a state of the database as it was at a certain time in history. To avoid mistakes in creating new tuples in the RTRepository, the tuples are cached right after the create operation. The client can remove or modify the tuples from the cache, as long as the commit service has not been called.

The most basic service assigns an IUI to a real world entity and creates its representation in the RTS. For instance, the call ‘ParticularPresentation particular=repository.createParticular Representation (tap, IUIₐ);’ creates first an A-tuple in the repository, assigns the metadata properties IUI_{d} and t_{d}, and then returns the instance.

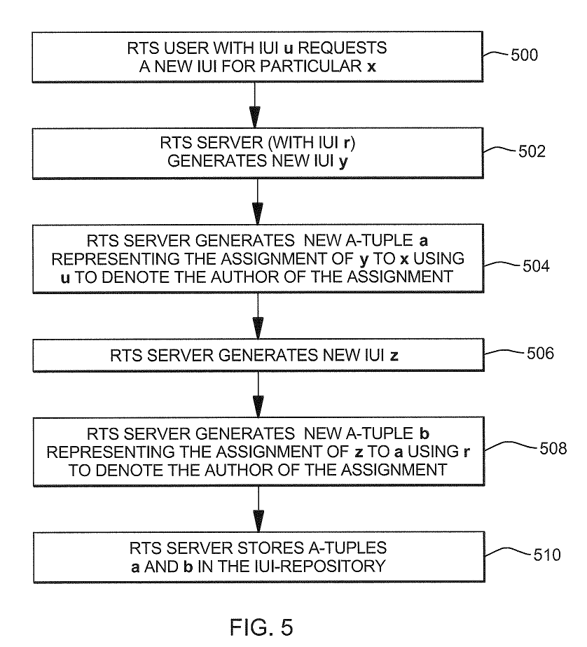

FIG. 5 shows one example of actions taken by the RTS to store the A-tuples when a user decides to assign an IUI to a new particular. Referring to FIG. 5, in one example, an RTS user with IUI u requests a new IUI for a particular x, STEP 500. The RTS server (with IUI r) generates a new IUI y, STEP 502. The RTS server then generates a new A-tuple “a” representing the assignment of y to x using u to denote the author of the assignment, STEP 504. The RTS server generates a new IUI z, STEP 506. The RTS server then generates new A-tuple b representing the assignment of z to a using r to denote the author of the assignment, STEP 508. The RTS stores A-tuples a and b in the IUI repository, STEP 510.

The next step is to assign detail to this particular. For example, the call ‘PtoU ptou=repository.createPtoU(particular.getIUI( ), IUIa, “rts.ri/OBO_REL/instance_of”, “rts.u//FMA/Left+forearm”, ta, tr),’ relates the particular created earlier to the Left forearm class (represented through a PtoU tuple) of the FMA (Foundational Model of Anatomy) by means of the instance_of relation from the OBO (Open Biomedical Ontologies) relation ontology. The arguments for the service call are, for instance, generated by means of the middleware component discussed further which translates the data from the data capture screens of the external information system into the referent tracking data types, as discussed herein.

Table 4 below shows various create services:

| Service Name | Service Description |
|---|---|
| startTransaction( ): | This service prepares the data store cache for a |
| | specific session of a user for create services. |
| cancelTransaction( ) | Discard all the tuples in the cache. |
| commitTransaction( ): | It permantely stores the contents of the data |
| | store cache. |
| createD(IUI_{d}, IUI_{A}, t_{d}, E, C, S): | 1) It checks whether the particulars denoted by |
| | arguments IUI_{d} and IUI_{A} are registered in the |
| | RTS. If they are not registered, it sends an error |
| | to the caller of the service. Otherwise, continue |
| | to step 2. |
| | 2) It generates a unique identifier for the new |
| | tuple D. |
| | 3) It creates a new tuple D, assigns it the new |
| | identifier and puts it in the cache. |
| | 4) Finally, it returns the new tuple D. |
| createParticularRepresentation(IUIₐ, tₐₚ): | 1) It generates a new IUI for a particular. |
| | 2) It creates a new A tuple and puts it in the |
| | cache. |
| | 3) It calls the createD service to insert its |
| | corresponding D tuple. |
| | 4) Finally, it returns the A tuple. |
| createIdentifier(IUIₐ, tₐₚ): | This service creates a unique identifier to the |
| | particular which is not an IUI (though still a |
| | denotator) because it doesn't satisfy the |
| | requirement of singularity. |
| | 1) It generates a unique identifier for a |
| | particular. |
| | 2) It creates a new denotator tuple and puts it in |
| | the cache. |
| | 3) It calls the createD service to insert its |
| | corresponding D tuple. |
| | 4) Finally, it returns the denotator tuple. |
| createPtoP(IUIₐ, tₐ, r, IUIₒ, P, tᵣ): | 1) It checks whether the particular denoted by |
| | argument IUIₐ and all particulars in the ordered |
| | list P are registered in the RTS. If they are not |
| | registered, it sends an error to the caller of the |
| | service. Otherwise, it continues to step 2. |
| | 2) It generates a unique identifier for a new |
| | PtoP tuple. |
| | 3) It creates a new PtoP tuple, assigns it the |
| | new identifier and puts it in the cache. |
| | 4) It calls the createD service to insert its |
| | corresponding D tuple. |
| | 5) Finally, it returns the new PtoP tuple. |
| createPtoU(IUIₐ, tₐ, inst, IUIₒ, IUIₚ, UUI, tᵣ): | 1) It checks whether the particulars denoted by |
| | arguments IUIₐ, IUIₒ and IUIₚ are registered in |
| | the RTS. If they are not registered, it sends an |
| | error to the caller of the service. Otherwise, it |
| | continues to step 2. |
| | 2) It generates a unique identifier for a new |
| | PtoU tuple. |
| | 3) It creates a new PtoU tuple, assigns it the |
| | new identifier and puts it into the cache. |
| | 4) It calls the createD service to insert its |
| | corresponding D tuple. |
| | 5) Finally, it returns the new PtoU tuple. |
| createPtoC(IUIₐ, tₐ, IUI_{c}, IUIₚ, CUI, tᵣ): | 1) It checks whether the particulars denoted by |
| | arguments IUIₐ, IUI_{c} and IUIₚ are registered in |
| | the RTS. If they are not registered, it sends an |
| | error to the caller of the service. Otherwise, it |
| | continues to step 2. |
| | 2) It generates a unique identifier for a new |
| | PtoC tuple. |
| | 3) It creates a new PtoC tuple, assigns it the |
| | new identifier and puts it into the cache. |
| | 4) It calls the createD service to insert its |
| | corresponding D tuple. |
| | 5) Finally, it returns the new PtoC tuple. |
| createPtoN(IUIₐ, tₐ, nt, n, IUIₚ, tᵣ, IUI_{c}) | 1) It checks whether the particulars denoted by |
| | arguments IUIₐ, IUI_{c} and IUIₚ are registered in |
| | RTS. If they are not registered, it sends an error |
| | to the caller of the service. Otherwise, it |
| | continues to step 2. |
| | 2) It generates a unique identifier for a new |
| | PtoN tuple. |
| | 3) It creates a new PtoN tuple, assigns it the |
| | new identifier and puts it in the cache. |
| | 4) It calls the createD service to insert its |
| | corresponding D tuple. |
| | 5) Finally, it returns the new PtoN tuple. |
| createPtoLackU(IUIₐ, tₐ, r, IUIₒ, IUIₚ, UUI, tᵣ): | 1) It checks whether the particulars denoted by |
| | arguments IUIₐ, IUIₒ and IUIₚ are registered in |
| | the RTS. If they are not registered, it sends an |
| | error message to the caller of the service. |
| | Otherwise, it continues to step 2. |
| | 2) It generates a unique identifier for a new |
| | PtoU(−) tuple. |
| | 3) It creates a new PtoU(−) tuple, assigns it the |
| | new identifier and puts it in the cache. |
| | 4) It calls the createD service to insert its |
| | corresponding D tuple. |
| | 5) Finally, it returns the new PtoU(−) tuple. |

Retrieval Services

The API retrieval methods help in searching the particulars in the RT repository. Particulars can be searched by means of any data associated with them, such as their names, the ontology classes of which they are instances, or the creation and observation dates.

The following table provides a few examples of such services:

TABLE 5
Services to Search Data Store

| Service Name | Service Description |
|---|---|
| getParticularsWithPtoN (id, IUIₐ, tₐ, nt, n, IUIₚ, tᵣ, IUI_{c}) | 1) It directly searches PtoN tuples in the data |
| | store by lexical matching of the parameters |
| | passed in the arguments with the attributes of |
| | the PtoN tuples. |
| | 2) For each tuple, it retrieves the corresponding |
| | tuple A and puts both tuples in the result set. |
| | 3) Finally, it returns the result set. |
| getParticularsWithPtoCo (id, IUIₐ, tₐ, IUI_{c}, IUIₚ, CUI, tᵣ) | 1) It directly searches PtoC tuples in the data |
| | store by lexical matching of the parameters |
| | passed in the arguments with the attributes of |
| | the PtoC tuples. |
| | 2) For each tuple, it retrieves the corresponding |
| | tuple A and puts both tuples in the result set. |
| | 3) Finally, it returns the result set. |
| getParticularsWithPtoLackU (id, IUIₐ, tₐ, r, IUIₒ, IUIₚ, | 1) It directly searches PtoU(−) tuples in the data |
| UUI, tᵣ) | store by lexical matching of the parameters |
| | passed in the arguments with the attributes of |
| | the PtoU(−) tuples. |
| | 2) For each tuple, it retrieves the corresponding |
| | tuple A and puts both tuples in the result set. |
| | 3) Finally, it returns the result set. |
| getParticularsWithPtoU (id, IUIₐ, tₐ, inst, IUIₒ, IUIₚ, | This method invokes one of two different |
| UUI, r, tᵣ) | algorithms depending on what parameters are |
| | submitted: |
| | 1) If the arguments r and UUI and IUIₒ are |
| | given, then the Inference Search algorithm is |
| | executed; |
| | 2) Otherwise, the Lexical Search algorithm is |
| | executed. |
| | Lexical Search: |
| | 1) It directly searches the PtoU tuple table for |
| | those tuples of which the values in the |
| | appropriate columns lexically match the |
| | parameters passed in the arguments of the |
| | query. |
| | 2) For each such matching PtoU-tuple, it |
| | retrieves the corresponding A-tuple and puts |
| | both tuples in the result set. |
| | 3) Finally, it returns the result set. |
| | Inference Search: |
| | 1) It directly searches the PtoU tuple table by |
| | lexically matching the parameters passed in the |
| | arguments (except for r and UUI and IUIₒ) with |
| | the values in the appropriate columns of each |
| | PtoU-tuple in the table. |
| | 2) If any tuples are returned, it loads the |
| | OntologyConnector component (see Table 6) |
| | for the ontology IUIₒ. |
| | 3) For each PtoU tuple returned in the previous |
| | step, it queries the ontology system IUIₒ with |
| | the help of the OntologyConnector for any |
| | universal represented in ontology IUIₒ which |
| | stands in the relation r with the universal |
| | denoted by UUI. |
| | 4) If there is at least one such universal |
| | represented in the ontology, then the logic |
| | retrieves for the original PtoU tuple the |
| | corresponding A tuple and puts both tuples in |
| | the result set. |
| | 5) Finally, it returns the result set. |
| getParticularsWithPtoC (id, IUIₐ, tₐ, IUI_{c}, IUIₚ, | This method has two algorithms. If the |
| CUI, is _a, tᵣ) | arguments is _a, CUI and IUI_{c} are given, then an |
| | inference search is exeucted; otherwise a |
| | lexical search. |
| | Lexical Search: |
| | 1) It directly searches into PtoC tuples by |
| | lexically matching the parameters passed in the |
| | arguments with the attributes of the PtoC |
| | tuples. |
| | 2) For each tuple, it retrieves the corresponding |
| | tuple A and puts both tuples in the result set. |
| | 3) Finally, it returns the result set. |
| | Inference Search: |
| | 1) It directly searches PtoC tuples by lexically |
| | matching the parameters passed in the |
| | arguments except r and CUI and IUI_{c} with the |
| | attributes of the PtoC tuples. |
| | 2) If tuples are returned, then it loads the |
| | OntologyConnector component for the |
| | terminology IUI_{c}. |
| | 3) For each PtoC tuple returned in the previous |
| | step, it queries the terminology system IUIc |
| | with the help of the OntologyConnector for any |
| | defined class represented in the terminology |
| | which stands in the relation is _a with the |
| | defined class denoted by CUI. |
| | 4) If there is at least one such defined class |
| | represented in the terminology, then the logic |
| | retrieves for the original PtoC tuple the |
| | corresponding A tuple and puts both tuples in |
| | the result set. |
| | 5) Finally, it returns the result set. |
| getParticularsWithPtoPByPtoN (iuip, r2, PtoN: <id, | Retrieves all the particulars with the PtoN: <....> |
| IUIₐ, tₐ, nt, n, tᵣ, IUI_{c}>) | search pattern that stand in relation r to |
| | particular iuip. |
| | 1) It searches for PtoP tuples that lexically |
| | match the parameters iuip and r with P and r |
| | attributes, respectively. |
| | 2) For each matched PtoP tuple (for which the |
| | variable ‘ptop’ is used), it retrieves the IUIs in P |
| | except the IUI iuip, and stores these in the |
| | variable ‘iuis’. |
| | 3) For each IUI in iuis, it calls the |
| | getParticularsWithPtoN service by passing the |
| | parameters set PtoN: <.....>. |
| | 4) If the service in 3 returns PtoN tuples, it puts |
| | them with ptop and their corresponding A |
| | tuples in the result set. |
| | 5) Finally, it returns the result set. |
| getParticularsWithPtoPByPtoU (iuip, r2, PtoU: <id, | Retrieves all the particulars with the PtoU: <....> |
| IUIₐ, tₐ, inst, IUIₒ, UUI, r, tᵣ>) | search pattern that stand in relation r to |
| | particular iuip. |
| | 1) It searches for PtoP tuples that lexically |
| | match the parameters iuip and r with the P and r |
| | attributes, respectively. |
| | 2) For each matched PtoP tuple (for which the |
| | variable ‘ptop’ is used), it retrieves the IUIs in P |
| | except the IUI iuip, and stores these in the |
| | variable ‘iuis’. |
| | 3) For each IUI in iuis, it calls the |
| | getParticularsWithPtoU service by passing the |
| | parameters set PtoU: <.....>. |
| | 4) If the service in 3 returns PtoU tuples, then it |
| | puts these tuples together with ptop and their |
| | corresponding A tuples into the result set. |
| | 5) Finally, it returns the result set. |
| getParticularsWithPtoPByPtoC (iuip, r2, PtoC: <id, | Retrieves all the particulars with the PtoC: <....> |
| IUIₐ, tₐ, IUI_{c}, CUI, is _a, tᵣ>) | search pattern that stand in relation r to |
| | particular iuip. |
| | 1) It searches for PtoP tuples that lexically |
| | match the parameters iuip and r with P and r |
| | attributes, respectively. |
| | 2) For each matched PtoP tuple (for which the |
| | variable ‘ptop’ is used), it retrieves the IUIs in P |
| | except the IUI iuip, and stores thesse in the |
| | variable ‘iuis’. |
| | 3) For each IUI in iuis (i.e., iui), it calls the |
| | getParticularsWithPtoC service by passing the |
| | parameters set PtoC: <.....>. |
| | 4) If the service in 3 returns PtoC tuples then it |
| | puts these tuples together with ptop and their |
| | corresponding A tuples into the result set. |
| | 5) Finally, it returns the result set. |

The arguments in the above services can be ‘null’ to enable search with the most global wildcard. Because the search pattern in the services might match with several thousands of particulars and the network bandwidth might not allow the transfer of that many results to the clients, a limit can optionally be set in the RTS configuration file. What precise selection will be returned within that limit depends on the data source technology which the system administrator of the RTS decides to use or for which the organization has obtained appropriate third party licenses.

RTS Network Layer

Network layer 416 (FIG. 4) provides the communication services to send or receive messages over a network. In this layer, the server and proxy components use an internal protocol for communication within the scope of a group. A proxy peer component 414 can communicate with a server peer component (in particular, a referent tracking data access server 418 of a referent tracking server), in this example, when both components are members of the same group. Furthermore, if a peer in an organization provides server services for two groups, then it runs the server peer component for each group.

RTS Services Server:

RTS services server component 419 (of referent tracking data access server 418) provides central query execution services to a proxy peer functioning as a client. The server is implemented in a way similar to the Services Oriented Architecture (based on an idea similar to that of web services), in which a set of services (similar to remote procedures) are provided as a query mechanism. The XML language is used to send both query and results between peers. Implementing the query mechanism by using XML avoids making changes in the server and proxy components as new services are introduced.

Listing 1, below, shows an example of the createPtoN service which allows inserting PtoN tuples in the database. The Name element inside the RtsService element would hold the name of the service, and the elements inside the Params element would contain the parameters of the service. For the sake of simplicity, only two parameters are shown in this example: ‘iuip’ stands for the IUI of the particular for which statement PtoN is inserted and ‘ta’ stands for the time at which the PtoN statement is inserted.

Listing 1: An Example of an RTS Service Query

```
<RtsService>
  <Name>createPtoN</Name>
    <params>
      <iuip>IUI-50</iuip>
      <ta>1201890219266</ta>
      ...
    </params>
  </RtsService>
</RtsQuery>
```

In the architecture of one aspect of the present invention, it is not required that all server peer installations provide the same set of services. Services in a server are published via a RtsServicesFactory 440, an interface which returns the list of service handlers, where each service handler is responsible for the execution of a specific service. Each service handler is implemented as a class which has two methods: getServiceName( ) and handlService(queryXML).

The method getServiceName( ) returns the name of the service, e.g., createPtoN, for which this handler is implemented. The RtsServer component calls this method to match the service name in the query (which is sent by a client for execution). If the query name is matched with getServiceName, then the server calls the handleService method of this handler.

The handlService(queryXML) method handles the execution of a service and returns the results in the form of XML to the server. Then, the server sends the XML, including its header information (which is used for internal purposes between server and clients), to the client who sent the query.

To publish new services in a server, the server configuration file is modified to inform the server about the availability of the new services implemented as a Java class.

As an example, the RTS server executes the query in Listing 1, as follows:
1. The RtsServer receives the query.
2. The server looks into its configuration to get the list of service handlers.
3. The server iterates the service handlers and for each handler, it matches the service name returned from getServiceName with the contents of the Name element in the XML. When the service name is matched, it calls the handleService method by passing the XML as a parameter. In the case the service name is not matched, it returns an error message to the client “server does not support the service”.
4. A handleService method implementation is a programming logic. In this case, the handle matched with the createPtoN service name calls the createPtoN service of the RTS Data Store, as it is implemented to do so.
5. The data store executes the createPtoN service and returns the PtoN tuple.
6. The handleService method serializes the returned PtoN into an XML string and returns to the Server.
7. The server returns the XML to the client.

RTS Proxy:

RTS Proxy 414 is the client side implementation of the RTS server that provides interfaces to RTS clients. The output of the proxy client, when querying multiple servers in a group, is based on the idea of streaming such that it outputs a result as soon as it receives it from a server.

Just after building a successful connection to a server, a Proxy Peer requests a list of services from the Server Peer (e.g., insertPtoU, getPtoU, getPtoN, etc). The Proxy Peer uses this information to forward the RTS client query to the appropriate servers which handle the query. For example, in FIG. 2, one server alone (out of the other servers running in organization A) handles the createPtoN service and, should a client request the Proxy Peer to execute the createPtoN service, the Proxy forwards the service call to that RTS server which handles the createPtoN service.

In one example, the Proxy component is implemented in such a way that it need not be changed if a server announces a new service. Since the service calling mechanism uses XML as a data format, the proxy component provides a RtsQueryService class to build a service query in XML. To create a service as in Listing 1, an object of the type of RtsQueryService class is created first. The service name, e.g. ‘createPtoN’, is assigned through the object method setServiceName(“createPtoN”). The parameters of the RtsQueryService object are assigned through the setParam method by supplying name-value pairs ( e.g. <“IUIp”, “IUI-50”>) as in setParam(“IUIp”, “IUI-50”). After the RtsQueryService object has been fully specified, it is serialized into the service query XML string as shown in Listing 1.

The proxy communicates with the server with the following protocol, as an example:
1. Just after building a successful connection to a server, a Proxy Peer requests a list of services from the Server Peer (e.g., createPtoN, getPtoU, getPtoN, etc).
2. A User calls its sendQuery( . . . ) method to send a service query (in the Listing 1) for execution to remote servers. The Proxy component is implemented in such a way that it need not be changed if a server announces a new service. Since the service calling mechanism uses XML as a data format, the proxy component provides a utility method to build a service query in XML.
3. The Proxy Peer uses the list of services (which it obtained in step 1) to forward the RTS client query to the appropriate servers which handle the query. For example, in FIG. 2, one server alone (out of the other servers running in organization A) handles the createPtoN service and, the Proxy forwards the service call to that RTS server which handles the createPtoN service.
4. After sending a query to the servers (in this particular case, it sends to only one server), it waits for the results from the servers. So, as it receives a result, it outputs the result; it does not wait to get a response from all servers to output the aggregated results, in this example.

Reasoning Server 114 (FIG. 1)

Reasoning is a part of the RTS and its purpose is double: first to avoid inconsistent data from being entered, and second to draw inferences during the execution of the search queries using the generic knowledge expressed in the terminology servers used to annotate the data and by exploiting the reasoners that operate on them. Various third party reasoners exist, some being specific to a particular knowledge source, some coming with a public DIG (Description Logic Implementation Group) interface for description logic representations, while others use directly OWL-DL (Web Ontology Language-Description Logics).

In order to be able to deal with terminology servers and the various sorts of knowledge sources they offer (nomenclatures, thesauri, ontologies, . . . ), the RTS includes a Reasoning API which helps in sending reasoning queries uniformly to different terminology servers. The Reasoning API has an abstract class called OntologyConnector, which provides an interface to the external terminology systems by means of services (see Table 6 below). The interpretations of the OntologyConnector services are specific to a particular terminology server; therefore, there is a separate implementation of the OntologyConnector for each terminology server which is used to annotate the particulars in the RTS.

Examples of various OntologyConnector class services are described with reference to Table 6:

TABLE 6

| Service Name | Service Description |
|---|---|
| isUniversalExist(u): | 1) It checks in its cache whether the UUI u exists there. If it finds |
| | it, then it returns the UUI; otherwise, it goes to step 2. |
| | 2) It opens a connection with the terminology server for which this |
| | ontology connector is implemented. |
| | 3) It builds a query in the format which is acceptable to the |
| | terminology server and sends it. |
| | 4) Upon the receipt of the results from the terminology server, it |
| | interprets the results into true or false. |
| | 5) It stores the interpreted results in the cache and returns the |
| | interpreted results. |
| isRelationExistBetweenUniversals | 1) It checks in its cache whether the query triple <u1 r u2> exists |
| (u1, r, u2): | there. If it finds it, it then returns the query results from the cache; |
| | otherwise, it goes to step 2. |
| | 2) It opens a connection with the terminology server for which this |
| | ontology connector is implemented. |
| | 3) It builds a query in the format which is acceptable to the |
| | terminology server and sends it. |
| | 4) Upon the receipt of the results from the terminology server, it |
| | interprets the results into true or false. |
| | 5) It stores the interpreted results in the cache and returns the |
| | interpreted results. |
| getRelations(u1, u2) | 1) It checks in its cache whether the query exists there. If it finds |
| | it, it then returns the query results from the cache; otherwise, it |
| | goes to step 2. |
| | 2) It opens a connection with the terminology server for which this |
| | ontology connector is implemented. |
| | 3) It builds a query in the format which is acceptable to the |
| | terminology server and sends it. |
| | 4) Upon the receipt of the results from the terminology server, it |
| | interprets the results into a set of relations. |
| | 5) It stores the interpreted results in the cache and returns the |
| | interpreted results. |

Description logics are widely used for building ontologies. The reasoners for such ontologies may take from 1 second to a day to compute inferences over the ontology classes depending on their size and definitional complexity. Therefore, instead of directly communicating with the reasoners for each ontology, the RTS is able to compute all the inferences at one time and then to store the result as an inference graph in a database. Furthermore, because the execution time of the OntologyConnector services can range from milliseconds to minutes, depending on the query execution time in the external terminology system, the OntologyConnector caches the results returned from these systems. The cache is stored, for instance, in a RDBMS. During the execution of any of the OntologyConnector services, it first searches in the cache.

Reasoning is performed for any query which involves PtoU tuples. If, for example, the query getParticularsWithPtoPByPtoU(iuip=>rts:IUI-1, r=>rts:r//OBO_REL/has_part,PtoU.<UUI=>“Upper limb”, o=>“FAM”>) is executed, then first the IUIs for the particulars which are related to the particular rts:IUI-1 via the has_part relation are retrieved. Then, it retrieves the UUIs for the universals which are instantiated by the particulars denoted by these retrieved IUIs. Finally, it requests the terminology servers in which the universals are represented by calling the isRelationExistsBetweenUniversals(“Left forearm”, “Upper limb”, “part of”) service from the OntologyConnector instance of the specialized class implemented for the FMA ontology. If the service returns true, then it returns the resulting IUIs with their associated tuples.

Initialization of a Referent Tracking Server

When an RTS is installed in an organization, a system administrator creates a configuration file that includes basic information about the environment. The minimal information that is provided includes, for instance:
demographics of the system administrator (name, department, position, . . . );
a name of the organization in which the RTS is installed;
serial number of the application;
identifying information concerning the information systems with which the RTS is to communicate, including the terminology servers and the knowledge components associated with them.

When the RTS is then started for the first time, the setup information is translated into a series of A-tuples and D-tuples, while the corresponding generic information is loaded in the internal ontology.

Example of a Referent Tracking System Used in Combination with an Electronic Health Record (EHR) Operated by a User

EHR Environment

The EHR application has a mechanism to search for codes assigned to terms or concepts in a terminology (T), or to universals as in realism-based ontologies (RBO), via a search utility which could be launched as a graphical user interface (GUI) to a clinician while the clinician is documenting the patient encounter.

The EHR application has been connected to the RTS system during the initialization phase such that:
The EHR application is able to execute the services of an IUIComponent 130 (see FIG. 1) to, for instance, store information about IUIs that have been assigned by the RTS. This modification is such that execution of the service is invoked, in one example, just after the selection of the code (by the clinician) in the search utility.
The EHR application has a mechanism to store representations of IUIs.
A terminology server is running separately to provide terminology services to the IUIComponent and the RTS server.
The RTS server is running separately.
The IUIComponent is running separately as a web service over the tomcat http server, as an example.

Use Case Scenario

One day, John consults for a left femur fracture with Dr. Rose, who enters the data in his EHR system. This encounter involves many actions to be carried out before the data are finally translated in the referent tracking data types and stored in the referent tracking data store. These actions include, for example:

Action 1: The clinician makes the diagnosis that John has a left femur fracture.

Action 2: The clinician registers this diagnosis in the EHR application. To do this, he starts by searching for information about John in the EHR database, but since John is a new patient, he does not find a reference to him in the system. He then inserts John's demographic data in the demographic module of the EHR application.

Action 3: At this stage, the EHR application communicates adequately with the IUIComponent to search John in the RTS, as he might have been registered there already, as described below.

Action 3.1: In one example, the EHR application calls the services of the IUIComponent to find John's IUI, for instance by means offindPatientByName(“Name”, “John”), described below. This service communicates with the RTS to find a particular for which there is a PtoN-tuple that includes the name term pair (nⱼ, nᵢ) (“Name”, “John”). Finding a patient's IUI in the RTS might involve other sorts of identifiers such as a local patient id (patient number in the clinic, driving license number, social security number, and so forth). Relations between a particular and such identifiers can be expressed by means of PtoP tuples or PtoN tuples.

findPatientByName(“Name”, “John”).
The IUIComponent includes the reference of a RTS Proxy. It calls the following services of the Proxy to find the patient:
1. It finds the particulars' IUIs by calling the getParticularsWithPtoN(IUIa=>null, ta=>null, nt=>“Last Name”, n=>“John”, IUIp=>null, tr=>null, IUIc=>null).
2. For each IUIp (for which the variable ‘p’ is used) it obtained from the previous step, it calls the getPtoCo(IUIa=>null, ta=>null, IUIc=>“T”, IUIp=>p, CUI=>24176006, tr=>null) to check the particulars (whose IUIp is p) annotated with patient code (24176006) from T. If the getPtoCo returns a tuple, then this service put the IUIp in the result set.
Finally, it returns the result set.

Action 3.2: If John is not yet represented in the IUI-Repository, then the IUIComponent calls the RTS create services to insert the particular representation in the IUI-Repository as described in the following way, as an example:

1) createParticularRepresentation(tap=>date, IUIa=>“IUI-]”)

The order of the variable set <tap, IUIa> corresponds with the values in the create service for the tuple in the ParticularRepresentation table. IUIa stands for the IUI of the entity, in this case Dr. Rose, that wishes to assign a IUI to a yet unregistered entity, in this case John. During the execution of the create service, the RTS generates IUI-2 for the particular, then inserts the tuple in the ParticularRepresentation table, and finally a corresponding D-tuple in the Metadata table. Finally, the RTS server returns the “IUI-2” to the IUIComponent.

2)createPtoC(IUIₐ=>“IUI=1”, tₐ=>date, IUI_{C}=>T.IUIₚ=>“IUI-2”,CUI=>“116154003”, tᵣ=>date).

The values in the create service correspond to the variable set <IUIa, IUIp, ta, tr, rts:/cbs/co>, in which the variable names correspond to the attributes in the PtoC tuple and the 116154003 code correspond with the term “patient” in terminology T. During execution of the create service, the RTS inserts the tuple within the PtoC table and its corresponding D-tuple in the Metadata table.

createPtoN(IUIₐ=>“IUI-1”,tₐ=>date, nt=>“Name”, n=>“John”,IUIₚ=>“IUI-2”, tᵣ=>date ,IUI_{c}=>c)

The order of the variable set <IUIₐ, IUIₚ, tₐ, tᵣ, ntⱼ, nᵢ> corresponds with the values in the create service for the tuple in the PtoN table. During the execution of the service, the RTS inserts the PtoN tuple in the PtoN table, and its corresponding D-tuple in the Metadata table.

Action 4: After calling the RTS create services, the IUIComponent sends the “IUI-2” to the EHR application. The EHR system stores that “IUI-2” denotes patient John.

Action 5: After adding the patient demographic data, the clinician opens an encounter input screen from the EHR system to write down his diagnosis. At this stage, the EHR system internally ‘knows’ that the patient for whom the documentation is being entered is John, and it ‘knows’ also that John's IUI is IUI-2.

Action 6: During the encounter documentation, the clinician searches for “left femur fracture” in terminology T with the interfaces provided by the EHR application. Unfortunately, T does not contain that term, and therefore, the clinician decides to use a combination of two other terms, one with CUI “419161000” and term “Unilateral left” and one with CUI “71620000” and term “Fracture of femur” to describe John's Left femur fracture.

Action 7: The EHR application calls the getIUI(“IUI-2”, {419161000, 71620000}) service of the IUIComponent. The getIUI service searches the RTDS for IUIs denoting particulars (having any relation with the particular #IUI-2 (John)) that are already annotated with these codes through the following steps, as one example.

Action 7.1: During execution of the getIUI service, the IUIComponent first executes the RTS service:

getParticularsWithPtoPByPtoC(iuip=>“IUI-2”,r2=>null,PtoC :<IUI_{c}=>T. CUI=>“71620000”,is_a=>“is_a”>)

to retrieve the IUI for a particular in relation to patient John (#IUI-2) which has the is_a relation with 7162000 (Fracture of Femur) in terminology T. In this case, the service finds nothing in the repository and notifies this to the IUIComponent. As the getIUI service receives no applicable IUI, it does not further search particulars annotated with the other code 419161000 (Unilateral left).

Action 8: As no particular is found in RTS, the IUIComponent calls the create services of the RTS to insert the new particular representation in the context of patient John, which generates IUI-3. The IUIComponent then inserts both CUIs (419161000 and 71620000) with the same timestamp.

Method To Translate Data from External In formation Systems into a Referent Tracking Compatible Format.

An advanced application is presented demonstrating how data collected by an Electronic Health Record application (EHR) can be reformulated to be compatible with the requirements of referent tracking, namely that the particulars assigned an IUI are instances of the kinds included in a realism-based ontology.

A typical EHR application enables a user to generate a fully readable, highly detailed progress note using only point-and-click controls as input. This is accomplished by creating a multitude of “control” types of which many are built up from one of four basic types (Checkbox, Radio Buttons, Checklist, and Number Box) and whose instances are used by clinicians to document the patient encounter. The output of the controls is formed by merging the input from the user into a predefined parameterized sentence. This design is well suited to the integration of a referent tracking system as each control in the application has a finite set of possible statements as output. Each of these statements can be linked to an RT compatible reformulation during design-time rather than at run-time. As an example, this is explained for a data-form control that is used to enter information on the strength of flexions of the feet.

As RT requires its IUIs, in one example, to refer only to spatiotemporal particulars (instances), its integration into an EHR application sometimes requires expanding single data elements from an EHR into several data elements. This expansion is performed in order to make explicit all of the references that an EHR data element contains only implicitly under current paradigms which focus on what are called concepts. The expansions that are performed follow the ontological—in contrast to biological—dependency relations that hold between the various types of particulars, as described in realism-based ontology and that, as explained further below, lead to the distinction of the three types of particulars relevant for these purposes, namely: (1) independent continuants (e.g. John Smith), (2) dependent continuants (e.g. John Smith's left femur fracture), and (3) occurrents (e.g. the healing of John Smith's left femur fracture).

Data elements which refer directly to independent continuants, such as persons and their body parts, require no expansion. Elements which refer to other types of particulars, such as weights, blood pressures and measurement acts themselves, do require expansion, in one example, so that all of the particulars on which the particulars they refer to depend are explicitly mentioned. This requirement is meant to ensure that there are no dangling references within the RTS: if the RTS stores a reference to a fracture, it also stores a reference to the bone that is fractured.

The main subdivision among particulars is based upon whether or not they have temporal parts, that is, on whether or not at any moment of time an entity is fully present or is instead only partially present. The former type of entity is a continuant and the latter an occurrent.

A subdivision of continuants (but not occurrents) is that between independent or dependent entities. An independent entity is for example a molecule or a cell. A dependent entity is for example the shape of a molecule or cell. The latter require the former in order to exist (in an ontological sense of ‘require’ that is different from what is involved for example when we say that organisms require food or oxygen). John Smith's left femur is an independent continuant—there is no other particular on which it depends in this ontological sense. The fracture of John Smith's left femur, in contrast, depends ontologically upon another continuant particular: the left femur itself. Each of these distinctions among entities is mutually exclusive and pair-wise disjoint. They yield a total of four distinct categories of particulars. But since all occurrent particulars are dependent entities (they all require one or more independent continuants which serve as their bearers), there are just three categories left: dependent and independent particulars on the one hand, and occurrents on the other.

A first step in making an EHR application RT compatible is to make an analysis of how current data from the EHR application is to be restructured. To accomplish this, for each type of assertion in the EHR, the following tasks are completed, (based upon the distinctions amongst entities as described and on the needs which EHR are to serve, e.g. in providing traceable liability):
1. Identify the particulars to which reference is made in the assertion;
2. Identify the relations which are stated to hold between the particulars;
3. Identify the universals of which the particulars are instances;
4. Identify any concepts or terms with which the particulars are annotated;
5. Determine whether the assertion consists of a negative finding; and
6. Identify the association of a customary name to a particular.

RT requires, in one example, further information about the state of affairs referred to by an assertion to be expressed by means of one of the following types of statements:
1. The assignment of an IUI to a particular (e.g., that #321 stands proxy for John Smith and #7865 for John Smith's left femur), which is achieved through the A-tuple data type;
2. The description that at the indicated time a certain relationship holds between particulars (e.g., that #7865 is a part of #321, requiring also that ‘is a part of’ is described in a BFO (Basic Formal Ontology) compatible relationship ontology), which is achieved through the PtoP-tuple data type;
3. The description that at an indicated time a particular is an instance of a given universal (e.g., that #7865 is a femur), which is achieved through the PtoU-tuple data type.
4. The annotation of a particular with a code from a concept-based system (e.g., that #7865 may be annotated with the SNOMED CT codes “182060005” or “T-12739”), which is achieved through the PtoC-tuple data type;
5. The description of a negative finding (e.g., that #321 lacks a left femur, i.e. that the time in question is after #7865 broke and before the pieces had grown back together), which is achieved through the PtoU(−)-tuple data type;
6. The association to a particular of a customary name (e.g., that #321's name is ‘John Smith’), which is achieved through the PtoN-tuple data type; and
7. The meta-description of a statement, namely, that the statement has been added to the RTS by a specific agent at a given time, which is achieved through the D-tuple data type.

The data-entry control that is being used in this example can generate the following sentence which then is stored in that form in the patient's EHR: “The patient's strength of right foot plantar flexion is ⅗.”

This sentence includes references to multiple particulars. In the example EHR, however, the EHR only assigns to the entire data element generated by the control one globally unique identifier which is formed through the concatenation of (i) the identifier it assigns to the patient session during which the control is used, with (ii) the identifier it assigned to the control itself. Note that (ii) is the same independently of the patient and session involved. Such a concatenated identifier does not qualify as a IUI for an entity on the side of the patient. Rather, it is as if the identifiers for the various individual particulars are “hidden” in the sentences generated by the control in a way which causes problems when these sentences are used for reasoning, and may even prevent reasoning from occurring at all.

The statement ‘The patients strength of right foot plantar flexion is ⅗’ is interpreted as being elliptical for: ‘The measurement of the strength of the patient's right foot plantar flexion yielded a value of 3 on a scale from 0 to 5.’

The particulars and associated ontological categories explicitly referred to by this sentence are thus, in one example:
P1: The patient's act of right foot plantar flexion—Occurrent
P2: The act of giving counterforce to P1—Occurrent
P3: The assessment that the equality of forces with which P1 and P2 are applied justifies a score of ⅗—Occurrent

Tracing the dependency relations of these particulars reveals the particulars that are implicitly referred to:
P4: The examiner who performed P3—Independent Continuant
P5: The patient's right foot plantar muscle group—Independent Continuant
P6: The disposition of the patient's right plantar muscle group to plantar flex the patient's right foot with a certain strength—Dependent Continuant
P7: The patient—Independent Continuant

The relationships that obtain between these particulars are:
R1: P7 (the patient) has part P5 (his right foot plantar muscle group)
R2: P6 (the disposition of the patient's right plantar muscle group) inheres in P5 (his right foot plantar muscle group)
R3: P5 (the patient's right foot plantar muscle group) participates in P1 (the patient's act of right foot plantar flexion)
R4: P7 (the patient) is agent in P1 (the act of right fool plantar flexion)
R5: P6 (the disposition of the patient's right plantar muscle group) is realized in P1 (the act of right foot plantar flexion).
R6: P3 (the assessment of equality) is preceded by P1 (the patient's act of flexion) and P2 (the examiner's act of giving counterforce);
R7: P4 (the examiner) is agent in P2 (the act of giving counterforce to P1)
R8: P4 (the examiner) is agent in P3 (the assessment of equality of the forces with which P1 and P₂ are exercised).
R9: The force with which P1 (the patient's act of plantar flexion) is exercised is equal to the force with which P2 (the examiner's act of giving counterforce) is exercised (and is expressed by the score of ⅗)

Finally, for each particular, it is also specified in the given example what universals they instantiate. This is done at that level which qualifies the universals as instantiating particulars of one of the three categories that indicate whether or not an entity is dependent. This led to four universals, in this example: Process (occurrent), Object (independent continuant), Disposition (dependent continuant), and Object Aggregate (independent continuant).

The instantiations of these universals are then:
I1: P1 is-instance-of Process
I2: P2 is-instance-of Process
I3: P3 is-instance-of Process
I4: P4 is-instance-of Object

I5: P5 is-instance-of ObjectAggregate
I6: P6 is-instance-of Disposition
I7: P7 is-instance-of Object

So in this case, making the single statement “The patient's strength of right foot plantar flexion is ⅗” from the EHR application compatible with the requirements of RT requires translating it into a set of 23 more detailed statements, as an example.

The process of expanding a data element such as is illustrated above to make explicit all of the implicit references to particulars that it may contain can thus be described in a few steps:
1) Identify all the particulars that are explicitly referred to by the element in question.
2) For each entity determine its ontological category.
3) Independent continuants require no further expansion. If an entity is a dependent continuant, identify the independent continuant on which it depends. If an entity is an occurrent, identify the continuants which participate in it.
4) Repeat steps 2) and 3) as required.

These steps are performed only once: e.g., when the EHR system is integrated with a RTS.

RTS—Middleware Component

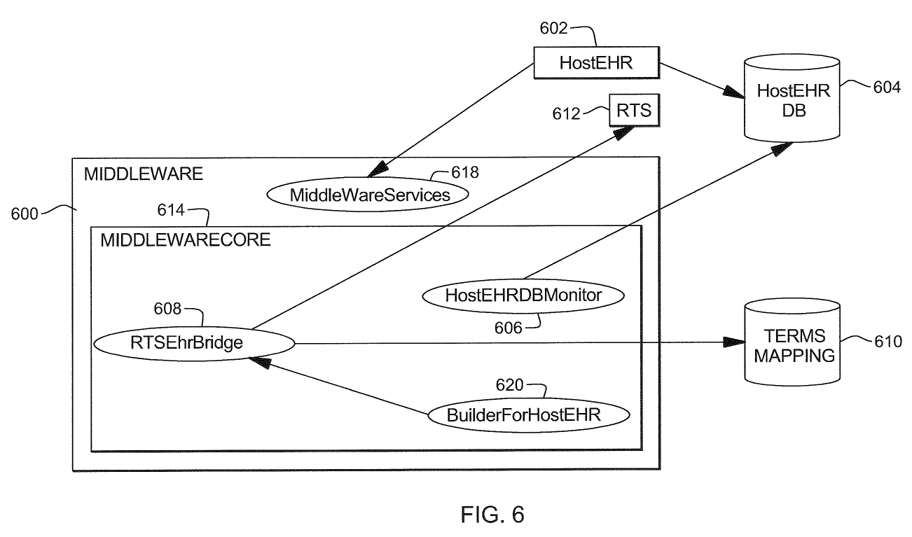

For efficiency, a middleware component has been created which provides a bridge between the RTS and the host application which is referred to as “HostEHR”. As the HostEHR saves the patient encounters as XML, this design has been exploited to use the same XML for the communication between the RTS and the HostEHR. The middleware component identifies particulars by iterating through the XML and calls the services of the RTS on behalf of the HostEHR to annotate the particulars with IUIs. This approach keeps the HostEHR application and the RTS integration specific implementations at separate places. One example of the design of the middleware application is depicted in FIG. 6, in which the arrows show the data flow between the components.

As one example, a middleware component 600 is designed to run as a standalone application and to provide its interface to a HostEHR 602 via web services following several communication scenarios, which each employ a distinct level of integration. One scenario is to monitor the HostEHR database 604 for new transactions related to patient encounters. In response to a monitoring component (HostEHRDBMonitor) 606 finding newly entered patient data, it forwards them to a RTSEhrBridge component 608 for further processing. Another approach is that HostEHR 602 sends the data actively via web services to the middleware application just before or after saving the encounter data. After annotating the identified particulars with the appropriate IUIs, the middleware application returns the results to the HostEHR. This approach, in contrast to the previous one, allows the HostEHR to manage the IUIs at the time of documenting the encounter. For both approaches, in one example, software changes are made in the HostEHR, the latter more drastically than the former.

The middleware application is also designed as a library, so that EHR applications can embed it easily in their programming environments. The middleware application includes middleware services 618 that translates the information in an information system into a format for the RTS.

Web Services

The Web Services provides an interface to the remote clients by forwarding the clients’ requests to the bridge component. They are remote procedures that can be invoked from any programming environment.

Term Mapping Database

The information regarding which particulars are possibly referred to when an input control is used in the context of an encounter is stored in a term mapping database 610 coupled to RTS EhrBridge 608. ‘Possibly’ here refers to the fact that some particulars may already be listed in the RTS such that, in line with the RT paradigm, the IUI already assigned to them is used for further reference. Other particulars might not yet be denoted in the RTS, in which case a new IUI is created. Deciding what is the case for a given data element can be accomplished by looking at the ontological characteristics of the universals (types, kinds) of which the particulars under scrutiny are instances and under what scenario they are referred to in the HostEHR. Four different cases are identified herein.

Case 1 involves particulars which exist throughout the life of a particular patient, examples being the patient himself, most body parts (e.g. his brain), some diseases (e.g., his diabetes) and some conditions, such as his blood pressure. Whenever these particulars are first observed, they are assigned an IUI, and that IUI is to be used in all future EHR statements made about them. This case encompasses also particulars which do not necessarily exist throughout a patient's life time, but which are assumed to still exist when they are referred to in the context of a new observation. Thus, a patient can indeed lose his left foot, but if a clinician states to have measured the strength of a patient's left plantar flexion, then this foot must exist.

Some particulars start to exist at t1 and disappear at t2, such as, hopefully, a fracture of the femur, or the flexion of his foot. Furthermore, John may have more than one femur fracture in his life and, without doubt, will flex his left foot quite often, each flexion being a new particular. However, in the context of, for instance, a follow-up encounter, some particulars can not be the same as observed during a previous encounter, while others may be the very same particulars as observed before. This leads to three further cases.

Case 2 involves particulars which may be re-observed, but the context of the encounter is such that it can be decided upon automatically whether or not a new or existing one is observed. As an example, if John breaks his left leg and therefore visits a clinician at t1 for treatment, then the HostEHR would record that John (#IUI-1) has a femur fracture (#IUI-2) in his left leg (#IUI-3). For everyfollow up visit (t₂ . . . t₁) for that particular fracture, #IUI-3 is used. If John later breaks again his left femur, then a new IUI is assigned, and that this is the case can be derived from the context that a new visit is entered, and not a follow-up visit.

Case 3 involves particulars which can not be re-observed during a new encounter, a foot flexion being an example, a measurement act being another one. Here, there are primarily processes which have a life-time that is shorter than the duration of an encounter.

Case 4 involves particulars which may be re-observed, but the context of the encounter is such that—in contrast to case 2—it can not be decided upon automatically whether a new or existing one is observed. If, for example, the RTS already contains a reference to a femur fracture in John which was created in the context of a HostEHR disease model other than the femur-fracture disease model, then activation of the femur-fracture model alone provides not enough evidence for the former reference to be used automatically.

The practical consequence of the distinction drawn is that for particulars in case 1, a new IUI is to be assigned the first time they are observed, and that IUI is to be retrieved afterwards. In case 2, the EHR application can inform the middleware component whether a new IUI is to be assigned. In case 3, the RTS 612 would create automatically a new IUI without any further questions to be asked. In case 4, the clinician has to provide the information whether or not a new particular is involved

As an example, the data-entry control discussed above would make HostEHR 602 store the string ‘strength of rightfoot plantarflexion is ⅗’ in John's EHR. Therefore, Term Mapping Database 610, which can be viewed as an application ontology for the HostEHR, includes the information on how this string is to be interpreted in terms of the underlying particulars that are to exist in order for the string to be a true statement. That information is derived on the basis of an ontological analysis carried out a priori. The following table shows the results of this analysis, together with the classification of the particulars according to the four cases identified above:

| Particular | Case |
|---|---|
| P1: John's act of right foot plantar flexion | 3 |
| P2: the act of giving counterforce to P1 | 3 |
| P3: the assessment that the equality of forces with which P1 and P2 | 3 |
| are applied justifies a score of 3/5 | |
| P4: the person who performed P3 | 1 |
| P5: John's right foot plantar muscle group | 1 |
| P6: the disposition of John's right plantar muscle group to plantar | 1 |
| flex with a certain strength | |
| P7: John | 1 |
| P8: John's femur fracture | 2 |

The Term Mapping Database includes such an analysis for each data control used in the HostEHR. The Term Mapping Database also keeps track of which particulars belong to which parent-control such that decisions on whether or not a particular requires a new IUI in the context of a follow-up visit can reliably and automatically be made. In addition, the Term Mapping Database includes the information about the relations that are to exist between particulars if they are referred to in the context of a specific disease model.

The Middleware Core Component

A middlewarecore component 614 receives the HostEHR patient's encounter XML by monitoring database 604 or, in this example, the XML is sent by HostEHR 602 through web services. It is composed, for instance, of two software components: BuilderForHostEHR 620 and RTSEhrBridge 608.

BuilderForHostEHR component 620 is a parser for the HostEHR's XML structures. It extracts the EHR statements (such as strength of right foot plantar flexion is ⅗) by iterating over the XML source.

RTSEhrBridge component 608 first retrieves the configuration of involved particulars for each statement from the Term Mapping Database. Based on this information, as well as on the encounter context information (whether a new visit or a follow-up is being documented), it decides whether IUIs for the particulars are first to be searched for in the RTS, or are to be created directly.

To assess whether particulars are already listed in the RTS, the RTSEhrBridge queries for these particulars by means of statements of the form, for instance:

getParticularsWithPtoPByPtoC(iuip=>“IUI-1”,r2=>null,PtoC:<IUI_{c}=>T. CUI=>“24176006”>).

In case the particulars are not listed in the RTS, or when the information in the Term Mapping Database states this directly, the RTSEhrBridge requests the RTS to create new IUIs for those particulars by means of a series of statements of the form, for instance:

IUI-2=createParticular(IUIₐ=>IUI-10, tₐₚ=>“02/27/2007”);

createPtoC(IUIₐ=>>“IUI-10”, tₐ=>date, IUI_{c}=>T, IUIₚ>“IUI-2”, CUI=>24176006, tᵣ=>date).

createPtoP(IUIₐ=>“IUI-10” tₐ=>date, r=>“has_art”, IUIₒ=>O,P=>{“IUI-1, “IUI-2”}, tᵣ =>date).

The createParticular method, in the example above concerning IUI-10 which stands for John, creates a reference to a particular and returns its IUI. The createPtoC associates the HostEHR Rightfoot term with the particular IUI-2. The createPtoP method asserts the has_part relation between IUI-1 and IUI-2. The relation information between the particulars IUI-1 and IUI-2 is also found in the Term Mapping Database. After the IUI assignment is complete, the RTSEhrBridge class returns the IUIs to BuilderForHostEHR 620. When encounter data are sent to the middleware component, BuilderForHostEHR associates the IUIs at the appropriate places in the XML, e.g. along with the “strength of right foot plantar flexion is ⅗” phrase decomposed into particulars, and finally the resulting XML is sent back to the HostEHR.

In cases when it cannot be determined whether a new or existing particular is observed, for instance, under a scenario with less intimate integration or when the clinician is not willing to supply the additional information, the RTSEhrBridge class assigns a denotator which is a unique identifier to the particular but which is not an IUI because it does not satisfy the requirement of singularity. This identifier is created in the RTS by means of a statement of the type: ‘ID=createIdentifier(tₐₚ, IUIₐ)’. Because these identifiers are clearly distinguished from IUIs, it is possible to supply the missing information later and to replace the identifier accordingly with an appropriate IUI.

Change Management And Error Correction

The real world is subject to constant change, and so also is our knowledge thereof. To keep track of these two sets of changes in an RTS, any assertion concerning a relationship between entities is associated with an index for the time period during which the relationship obtains, for the time at which the assertion is made, and for the author of the assertion. When such an assertion is made, the RTS assumes that:
1) Each such assertion is assumed by the creators of the representation to be veridical, i.e. to conform to some relevant portion of reality (POR) as conceived on the best current scientific understanding (which may, of course, rest on errors);
2) Several different representations units may correspond to the same POR by presenting different though still veridical views or perspectives, for instance, at different levels of granularity (one thing may be described both as being brown and as reflecting light of a certain wavelength, or one event as an event of buying and of selling);
3) What is to be asserted in an RTS depends on the purposes which the representation is designed to serve.

Because data stored in referent tracking data stores, as thus conceived, (1) are artifacts created for some purpose and because (2) they are intended to mirror reality, and because (3) reasoning with the representations requires efficiency from a computational point of view, an optimal data store, in this example, is to contain data which constitute a representation of all and only those portions of reality that are relevant for its purpose. Clearly, things may go wrong on the way to achieving this optimal representation. First, users may be in error as to what is the case in their target domain, leading to assertion errors. Second, they may be in error as to what is objectively relevant to a given purpose, leading to relevance errors. Third, they may not successfully encode their views, so that particular representational units fail to point to the intended entities because of encoding errors.

An ideal data store, in this example, would be marked by none of these three types of errors. Each information bearer in such a data store would designate (1) a single POR, which is (2) relevant to the purposes of the host application, and such that (3) the authors of the representations intended to use this term to designate this POR. Moreover, (4) there would be no PORs objectively relevant to these purposes that are not referred to in the data store.

To keep the data in the data store consistent with the portion of reality they intend to describe, and at the same time to keep a historical view over what was believed to be the case at earlier times, its information will often be updated by adding appropriate tuples and corresponding D-tuples. The latter therefore have the parameters “C” and “E”, as described above.

Mistakes in Existing Tuples

Values for the C-parameter make explicit whether changes in a new version of a tuple are due to, for instance,

(1) A change in reality (code “CE”);

(2) A change in the authors’ understanding or beliefs thereof (code “CB”);

(3) A change in the relevance for inclusion of representations (code “CR”); or

(4) Correction of mistakes.

For corrections of mistakes, the E-parameter of the D-tuple can have several values, depending on what type of RT-tuple is in error.

A-tuples, as explained, are used to assert the existence of some particular in reality at some time, and to differentiate this particular from other particulars by assigning it an IUI as a globally unique and singular ID. Hence, A-tuples can be qualified as being in error for one or other of the following reasons, as examples:
A1: The ID does not refer;
A2: The ID refers to two (or more) distinct particulars;
A3: The ID is not the only ID in the RTS that refers to this particular;
A4: The ID does not refer to the intended particular.

PtoU-tuples, which relate a particular to a universal the reference to which is drawn from some external ontology, can be in error for many more reasons, including, for instance:
U1: The relationship between the particular referred to by the IUI and the universal in question does not hold during the stated time period;
U2: The ID for the universal does not refer to the intended universal or it refers to no universal at all.

Where the ID for the particular is subject to an A-type error, the following additional PtoU-errors may occur, as examples:
U3: There is an A1 error in the corresponding A-tuple: the PtoU-tuple is nonsensical;
U4: The ID is subject to a mistake of type A2 and for at least one of the particulars referred to by it, the stated relationship does not hold;
U5: The ID is subject of a mistake of type A3, and the particular referred to by the ID is not an instance of the universal during the stated time period;
U6: Similar to U5, but involving a type A4 mistake.

Four further types of mistakes are such that reality is mirrored by the PtoU-tuple in question, but what is mirrored is either not what was intended, or is irrelevant:
U7: The ID is subject of a mistake of type A2, but for all particulars referred to by it, the stated relationship holds;
U8: The ID is subject of a mistake of type A3, but the particular referred to by the ID is an instance of the universal during the stated time period;
U9: Similar to U5, but involving a type A4 mistake;
U10: There is no A-type of mistake but the stated relationship is irrelevant.

Similar situations, with corresponding error codes, are defined for all other tuples in a similar way. In one embodiment, those error codes are inserted into the D-tuple (by means of the E parameter) corresponding to the tuple in error.

Mistakes of Omission

All portions of reality that are relevant for the purpose for which the RTS is maintained should be represented by means of corresponding tuples. If not, the following mistakes occur, in both cases leading to the absence of an A-tuple, as examples:
A-1: The existence of a relevant particular is not acknowledged;
A-2: The relevance of a particular for the purpose of the RTS is not acknowledged.

Similarly, two further types of errors are recognized involving universals or particulars:
U-1/P-1: The existence of a relevant relationship between a particular and some other entity is not acknowledged;
U-2/P-2: The relevance of a relevant relationship between a particular and some other entity is not acknowledged.

Whereas mistakes of omission may occur independently of other mistakes, some mistakes of type A and type U will automatically bring in their wake mistakes of other types: Thus, for example, mistakes of type U6 and U9 are automatically associated with a mistake of type U-1.

Overview of Correction Logic

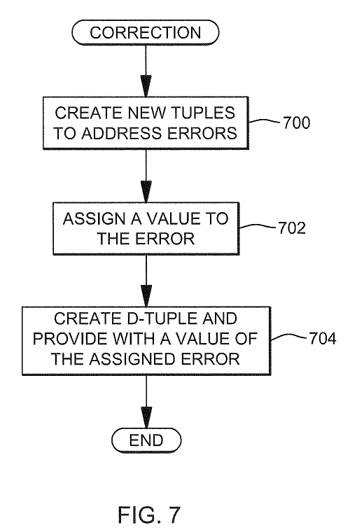

One example of an overview of the logic executed by the RTS to correct an error is described with reference to FIG. 7. In this example, new tuples are created that include the correct information, STEP 700. For instance, an A-tuple (or other tuple) is created with the correct information, and a corresponding D-tuple is created. Further, a value is assigned to the error, STEP 702, and a D-tuple corresponding to the incorrect A-tuple is created and provided with the assigned value for the error, STEP 704. This concludes the processing.

Example Scenario

Described herein is a simplified criminal case, based on a real case, to demonstrate the principles: Jul. b 15, 1984, 9-year-old Christie Hamilton was raped and murdered. Aug. 20, 1984, Stan Ruffner was imprisoned for rape and attempted murder on Louise Talbry. A composite sketch of the perpetrator in the Hamilton case was shown on the local news. Two anonymous callers advised that Kirk Peeters looked like the composite. Peeters was convicted of the murder. Oct. 5, 1993, new forensic tests discovered semen on Hamilton's underpants. DNA tests proved it was not Peeters'. Sep. 19, 2003, the DNA sample recovered from Hamilton's underpants was identified as that of Ruffner.

Described herein are the sequence of actions and corresponding logic employed to represent this case in a specific implementation of a referent tracking system that is assumed to have been set up in 1984. The corresponding states of the relevant parts of the referent tracking data store are shown in this specific implementation using simple tables, one table for each sort of tuple, with the columns—except for the last one—corresponding to the parameters used in the tuples as described above—“Referent Tracking Data Elements: RT-tuples”. Each row in any table corresponds with a new tuple instance. The last column of each tuple-table includes IUIs which represents the corresponding tuple-instances, and thus, can be seen as primary keys for the tuple-instances. This specific implementation thus leads to a more compact A-tuple table than what would be achieved by inserting two A-tuples for each assignment as described in FIG. 5, without, however, violating the principles.

Rather than displaying lengthy unique identifiers, surrogates of the form “IUI-x” are used, where “x” is a number.

Further, for the sake of the example, let FBI agent, John Smith, be responsible for the follow-up of the case and for registering all information, including the correction of mistakes, and also assume that the RTS itself was set up in the FBI by system administrator Barry Jones on Jan. 2, 1984.

Also, relevant parts of the internal ontology of the RTS used to annotate the particulars in the referent tracking system (RTS) are displayed.

Sequence 0: Installation of the RTS

Barry Jones, as designated system administrator for the RTS within the FBI, writes on Jan. 2, 1984 the configuration file as described above—Initialization of a Referent Tracking Server. The specific implementation of the RTS to be installed provides that the following initialization file is to be completed (“ * * * ” indicates parameters to be supplied by the system administrator):

<init>
<RTS-serialnumber>***</RTS-serialnumber>
<adminfirstname>***</adminfirstname>
<adminlastname>***</adminlastname>
<adminpassword>***</adminpassword>
<adminusername>***</adminusername>
<organizationname>***</organizationname>
</init>

The administrator fills out this file using a text editor, resulting in, for instance:

<init>
<RTS-serialnumber>768512</RTS-serialnumber>
<adminfirstname>Barry</adminfirstname>
<adminlastname>Jones</adminlastname>
<adminpassword>tpw1234</adminpassword>
<adminusername>bjones</adminusername>
<organizationname>FBI</organizationname>
</init>

Then, the initialization logic is launched (e.g., by the RTS data access server) which generates the following events, as an example:
1. It requests a first globally unique identifier from the IUI-generator which returns “IUI-1”;
2. It requests a second globally unique identifier from the IUI-generator which returns “IUI-2”;
3. It requests a third globally unique identifier from the IUI-generator which returns “IUI-3”;
4. It inserts the following record in the A-tuple table, representing that the particular denoted by IUI-2 (in this case Barry Jones, but that is not made explicit in the inserted A-tuple) assigned IUI-1 to some other particular (in this case, also not explicitly stated, the referent tracking server), and that this A-tuple assertion is assigned the IUI “IUI-3”:

| IUIₚ | IUIₐ | tₐₚ | A-key |
|---|---|---|---|
| IUI-1 | IUI-2 | 1984-01-02 | IUI-3 |

5. It requests a globally unique identifier from the IUI-generator which returns “IUI-4”;
6. It inserts the following record in the D-tuple table, representing that the corresponding A-tuple with IUI-3 was inserted (E=“I”) in the data store because of a change in reality (C=“CE” denoting change in reality: there existed indeed no referent tracking server in the FBI before the initialization):

| IUI_{d} | IUI_{A} | t_{d} | E | C | S | D-key |
|---|---|---|---|---|---|---|
| IUI-2 | IUI-3 | 1984-01-02 | I | CE | | IUI-4 |

7. It requests a globally unique identifier from the IUI-generator which returns “IUI-5”;
8. It inserts the following record in the A-tuple table, representing that the particular denoted by IUI-2 (in this case Barry Jones, but still not made explicit) assigned IUI-2 to itself and that this A-tuple assertion is assigned the IUI “IUI-3”:

| IUIₚ | IUIₐ | tₐₚ | A-key |
|---|---|---|---|
| IUI-2 | IUI-2 | 1984-01-02 | IUI-5 |

9. It requests a globally unique identifier from the IUI-generator which returns “IUI-6”;
10. It inserts the following record in the D-tuple table, representing that the corresponding A-tuple with IUI-5 was inserted (E=“I”) in the data store because of a change in relevance (C=“CR” denoting change in relevance: the particular denoted by IUI-2, i.e. Barry Jones, existed already, but he was not yet registered in the RTS):

| IUI_{d} | IUI_{A} | t_{d} | E | C | S | D-key |
|---|---|---|---|---|---|---|
| IUI-2 | IUI-5 | 1984-01-02 | I | CR | | IUI-6 |

11. It requests two globally unique identifiers from the IUI-generator which returns “IUI-7” and “IUI-8”;
12. It inserts the following record in the A-tuple table, representing that the particular denoted by IUI-2 assigned IUI-7 to some particular (the FBI, though at this point in the logic that is still not made explicit by means of associated RT-tuples) and that this A-tuple assertion is assigned the IUI “IUI-8”:

| IUIₚ | IUIₐ | tₐₚ | A-key |
|---|---|---|---|
| IUI-7 | IUI-2 | 1984-01-02 | IUI-8 |

13. It requests a globally unique identifier from the IUI-generator which returns “IUI-9”;
14. It inserts the following record in the D-tuple table, representing that the corresponding A-tuple with IUI-8 was inserted (E=“I”) in the data store because of a change in relevance (C=“CR” denoting change in relevance: the particular denoted by IUI-7, i.e. the FBI, existed already, but was not yet registered in the RTS):

| IUI_{d} | IUI_{A} | t_{d} | E | C | S | D-key |
|---|---|---|---|---|---|---|
| IUI-2 | IUI-8 | 1984-01-02 | I | CR | | IUI-9 |

15. It requests a globally unique identifier from the IUI-generator which returns “IUI-10”;
16. It inserts the following record in the N-tuple table, representing that the particular with IUI-2 stated that the RT server's serial number is 768512:

| | | | | | | | N- |
|---|---|---|---|---|---|---|---|
| IUIₐ | tₐ | nt | n | IUIₚ | tᵣ | IUI_{c} | key |
| IUI-2 | 1984- | RTS serial | 768512 | IUI-1 | 1984-01-02 | IUI-7 | IUI-10 |
| | 01-02 | number | | | | | |

17. It requests a globally unique identifier from the IUI-generator which returns “IUI-11”;
18. It inserts the following record in the D-tuple table, representing that the corresponding N-tuple with IUI-10 was inserted (E=“I”) in the data store because of a change in reality:

| IUI_{d} | IUI_{A} | t_{d} | E | C | S | D-key |
|---|---|---|---|---|---|---|
| IUI-2 | IUI-10 | 1984-01-02 | I | CE | | IUI-11 |

19. In similar steps as from 15 to 18, the initialization logic adds the tuples concerning the names of the particulars denoted by IUI-2 (Barry Jones) and IUI-7 (the FBI) in the N-tuple table, and corresponding meta tuples in the D-tuple table:

| | | | | | | | N- |
|---|---|---|---|---|---|---|---|
| IUIₐ | tₐ | nt | n | IUIₚ | tᵣ | IUI_{c} | key |
| IUI-2 | 1984-01-02 | first name | Barry | IUI-2 | 1984-01-02 | IUI-7 | IUI-12 |
| IUI-2 | 1984-01-02 | last name | Jones | IUI-2 | 1984-01-02 | IUI-7 | IUI-14 |
| IUI-2 | 1984-01-02 | organization name | FBI | IUI-7 | 1984-01-02 | IUI-7 | IUI-16 |

| IUI_{d} | IUI_{A} | t_{d} | E | C | S | D-key |
|---|---|---|---|---|---|---|
| IUI-2 | IUI-12 | 1984-01-02 | I | CR | | IUI-13 |
| IUI-2 | IUI-14 | 1984-01-02 | I | CR | | IUI-15 |
| IUI-2 | IUI-16 | 1984-01-02 | I | CR | | IUI-17 |

20. The initialization logic requests eight globally unique identifiers from the IUI-generator, which returns “IUI-18” to “IUI-25”;
21. The logic inserts the following records in the Internal Ontology (IO):

| denotator | denotator type | corresponding entity | IO-key |
|---|---|---|---|
| RTS-CUI-1 | CUI | RTS system administrator | IUI-18 |
| RTS-CUI-2 | CUI | RTS user | IUI-19 |
| RTS-CUI-3 | CUI | RTS username | IUI-20 |
| RTS-CUI-4 | CUI | RTS password | IUI-21 |
| IUI-22 | IUI | bjones | IUI-23 |
| IUI-24 | IUI | tpw1234 | IUI-25 |

22. It then requests six new IUIs and inserts the corresponding D-tuples for the recently added IO-records:

| IUI_{d} | IUI_{A} | t_{d} | E | C | S | D-key |
|---|---|---|---|---|---|---|
| IUI-1 | IUI-18 | 1984-01-02 | I | CR | | IUI-26 |
| IUI-1 | IUI-19 | 1984-01-02 | I | CR | | IUI-27 |
| IUI-1 | IUI-20 | 1984-01-02 | I | CR | | IUI-28 |
| IUI-1 | IUI-21 | 1984-01-02 | I | CR | | IUI-29 |
| IUI-1 | IUI-23 | 1984-01-02 | I | CR | | IUI-30 |
| IUI-1 | IUI-25 | 1984-01-02 | I | CR | | IUI-31 |

23. After requesting a new IUI, the initialization logic asserts that the particular denoted by IUI-2 is an RTS system administrator by inserting the following PtoC-tuple in which “768512-10” denotes the internal ontology of the RTS server which is being set up:

| IUIₐ | tₐ | IUI_{c} | IUIₚ | CUI | tᵣ | PtoC-key |
|---|---|---|---|---|---|---|
| IUI-2 | 1984- | 768512-IO | IUI-2 | RTS-CUI-1 | 1984-01-02 | IUI-32 |
| | 01-02 | | | | | |

24. The logic, after requesting a new IUI, adds the corresponding D-tuple for the PtoC-tuple just added. Because Barry Jones was not an RTS system administrator before, the record reflects a change in reality as motivation for the insertion:

| IUI_{d} | IUI_{A} | t_{d} | E | C | S | D-key |
|---|---|---|---|---|---|---|
| IUI-2 | IUI-32 | 1984-01-02 | I | CE | | IUI-33 |

25. The logic requests four new IUIs, two to assign to Barry Jones' username and password, and two for the corresponding A-tuples;
26. The assignments are asserted by inserting the following A-tuples:

| IUIₚ | IUIₐ | tₐₚ | A-key |
|---|---|---|---|
| IUI-34 | IUI-2 | 1984-01-02 | IUI-35 |
| IUI-36 | IUI-2 | 1984-01-02 | IUI-37 |

27. The logic inserts the corresponding D-tuples:

| IUI_{d} | IUI_{A} | t_{d} | E | C | S | D-key |
|---|---|---|---|---|---|---|
| IUI-2 | IUI-35 | 1984-01-02 | I | CE | | IUI-38 |
| IUI-2 | IUI-37 | 1984-01-02 | I | CE | | IUI-39 |

28. After requesting the required number of new IUIs, the logic asserts that the particular denoted by IUI-34 is a username, and the one denoted by IUI-36 a password, by inserting the appropriate PtoC-tuples:

| IUIₐ | tₐ | IUI_{c} | IUIₚ | CUI | tᵣ | PtoC-key |
|---|---|---|---|---|---|---|
| IUI-2 | 1984- | 768512- | IUI-35 | RTS-CUI-3 | 1984-01-02 | IUI-40 |
| | 01-02 | IO | | | | |
| IUI-2 | 1984- | 768512- | IUI-37 | RTS-CUI-4 | 1984-01-02 | IUI-41 |
| | 01-02 | IO | | | | |

29. After requesting the required number of new IUIs, the corresponding D-tuples for the previously generated PtoC-tuples are inserted:

| IUI_{d} | IUI_{A} | t_{d} | E | C | S | D-key |
|---|---|---|---|---|---|---|
| IUI-2 | IUI-40 | 1984-01-02 | I | CE | | IUI-42 |
| IUI-2 | IUI-41 | 1984-01-02 | I | CE | | IUI-43 |

30. After requesting the required number of new IUIs, the logic asserts that the particulars denoted by IUI-34 and IUI-36 belong to Barry Jones (denoted by IUI-2), by inserting the appropriate PtoP-tuples:

| | | | | | | PtoP- |
|---|---|---|---|---|---|---|
| IUIₐ | tₐ | r | IUIₒ | P | tᵣ | key |
| IUI-2 | 1984-01-02 | is- | 768512- | {IUI-34, | 1984-01-02 | IUI-44 |
| | | about | IO | IUI-2} | | |
| IUI-2 | 1984-01-02 | is- | 768512- | {IUI-36, | 1984-01-02 | IUI-45 |
| | | about | IO | IUI-2} | | |

31. After requesting the required number of new IUIs, the corresponding D-tuples for the previously generated PtoP-tuples are inserted:

| IUI_{d} | IUI_{A} | t_{d} | E | C | S | D-key |
|---|---|---|---|---|---|---|
| IUI-2 | IUI-44 | 1984-01-02 | I | CE | | IUI-46 |
| IUI-2 | IUI-45 | 1984-01-02 | I | CE | | IUI-47 |

32. After requesting the required number of new IUIs, the logic asserts that the particular denoted by IUI-34 (Barry Jones' username) is represented by IUI-22 (the generically dependent continuant expressed by the string “bjones”) and that the particular denoted by IUI-36 (Barry Jones' password) is represented by IUI-24 (the generically dependent continuant expressed by the string “tpw1234”), by inserting the appropriate PtoP-tuples. It inserts in the tᵣ-slot of the PtoP-tuple for the password (i.e. the tuple with key “IUI-49”) a time period rather than a time-point, indicating, in this case, that the string which is asserted to be a representation for the password is only valid as such for a period of 3 months:

| IUIₐ | tₐ | r | IUIₒ | P | tᵣ | PtoP-key |
|---|---|---|---|---|---|---|
| IUI-2 | 1984-01- | is-represented- | 768512- | {IUI-34, IUI- | 1984-01-02 | IUI-48 |
| | 02 | by | IO | 22} | | |
| IUI-2 | 1984-01- | is-represented- | 768512- | {IUI-36, IUI- | 1984-01-02/ | IUI-49 |
| | 02 | by | IO | 24} | 1984-04-02 | |

33. Finally, after requesting the required number of new IUIs, the logic terminates by inserting the corresponding D-tuples for the previously generated PtoP-tuples:

| IUI_{d} | IUI_{A} | t_{d} | E | C | S | D-key |
|---|---|---|---|---|---|---|
| IUI-2 | IUI-48 | 1984-01-02 | I | CE | | IUI-50 |
| IUI-2 | IUI-49 | 1984-01-02 | I | CE | | IUI-51 |

Sequence 1: Adding Agent John Smith as Authorized RTS-User

Adding new users is performed by the system administrator by calling a AddNewUser service which implements the following logic, in one example:
1. It calls the GetParticularNames service which through a user-interface proposes the system administrator to select existing name types from the “nt”-column of the PtoN-tuple table or to enter more suitable ones, and to provide values applicable for the user to be added in the corresponding n-slot of the PtoN-tuple.
2. It calls for each <nt, n> pair the getParticularsWithPtoN service to check whether there are already particulars to which these name-pairs are associated. If so, the administrator is offered the possibility to select the right individual by inspecting other information that is available about this particular (by means of other RT-tuples in which the corresponding IUI is mentioned) or to assert that the name-pairs, although assigned to other particulars, are also valid names for the new user. If not, a new particular is assumed automatically.
3. It calls the createParticularRepresentation service to create the A-tuple and corresponding D-tuple for the new particular, i.e. the user to be added.
4. It calls for each <nt, n> pair supplied the createPtoN service to create the corresponding PtoN-tuples and corresponding D-tuples.
5. It calls the createPtoC service to assert that the new particular may be annotated as being an RTS user.
6. It calls the createNewUserNameAndPassword service to create a temporary username and password for the new user.

Sequence 2: Registering Christie Hamilton's Murder

Jul. 16, 1984, 6.34 PM, agent John Smith registers in the RTS that on Jul. 15, 1984, 9-year-old Christie Hamilton was raped and murdered.

This involves the following steps, as an example:
1. John Smith (for example with IUI-560) logs on to the FBI-information system using his user name and password which through the RTS-middleware services is linked to the referent tracking system;
2. The referent tracking system checks the submitted data and grants access if they correspond to the data on file; otherwise rejects the request;
3. John Smith fills out an electronic form stating that on Jul. 15, 1984, Christie Hamilton, born Mar. 8, 1975, was raped and murdered;
4. The RTS middleware services detect the addition of data into the FBI-information system and translate these data into the Referent Tracking data types through the following steps.
5. The assignment of IUIs to the following four particulars is requested:
   a. Christie Hamilton
   b. Christie Hamilton's birth
   c. Christie Hamilton's rape
   d. Christie Hamilton's murder
6. The assignments are executed by means of the createParticularRepresentation service which assigns, for example the following IUIs to the four particulars:
   a. IUI-1001: Christie Hamilton
   b. IUI-1004: Christie Hamilton's birth
   c. IUI-1007: Christie Hamilton's rape
   d. IUI-1010: Christie Hamilton's murder

which results in the following tuples being added, as examples:

| IUIₚ | IUIₐ | tₐₚ | A-key |
|---|---|---|---|
| IUI-1001 | IUI-560 | 1984-07-16 | IUI-1002 |
| IUI-1004 | IUI-560 | 1984-07-16 | IUI-1005 |
| IUI-1007 | IUI-560 | 1984-07-16 | IUI-1008 |
| IUI-1010 | IUI-560 | 1984-07-16 | IUI-1011 |

| IUI_{d} | IUI_{A} | t_{d} | E | C | S | D-key |
|---|---|---|---|---|---|---|
| IUI-560 | IUI-1002 | 1984-07-16 | I | CR | | IUI-1003 |
| IUI-560 | IUI-1005 | 1984-07-16 | I | CR | | IUI-1006 |
| IUI-560 | IUI-1008 | 1984-07-16 | I | CE | | IUI-1009 |
| IUI-560 | IUI-1011 | 1984-07-16 | I | CE | | IUI-1012 |

7. Through the createPtoN service, Christie Hamilton's first name and last name are registered in PtoN-tuples, which leads to the following tuples:

| IUIₐ | tₐ | nt | n | IUIₚ | tᵣ | IUI_{c} | N-key |
|---|---|---|---|---|---|---|---|
| IUI-560 | 1984-07-16 | first name | Christie | IUI-1001 | 1975-03-08 | IUI-645 | IUI-1013 |
| IUI-560 | 1984-07-16 | last name | Hamilton | IUI-1001 | 1975-03-08 | IUI-645 | IUI-1015 |

| IUI_{d} | IUI_{A} | t_{d} | E | C | S | D-key |
|---|---|---|---|---|---|---|
| IUI-560 | IUI-1013 | 1984-07-16 | I | CR | | IUI-1014 |
| IUI-560 | IUI-1015 | 1984-07-16 | I | CR | | IUI-1016 |

8. Through the createPtoU service, it is asserted that the particulars represented by IUI-1001, IUI-1004, IUI-1007 and IUI-1010 are respectively instances of the universals person, birth, rape and murder, which leads to the following tuple additions (for the example, the IUI of the ontology which contains the UUIs for the universals are taken to be IUI-519 and the UUIs themselves to be UUI-20, UUI-21, UUI-23 and UUI-24):

| | | | | | | | PtoU- |
|---|---|---|---|---|---|---|---|
| IUIₐ | tₐ | inst | IUIₒ | IUIₚ | UUI | tᵣ | key |
| IUI-560 | 1984-07- | instance-of | IUI-519 | IUI-1001 | UUI-20 | 1975-03- | IUI-1017 |
| | 16 | | | | | 08 | |
| IUI-560 | 1984-07- | instance-of | IUI-519 | IUI-1004 | UUI-21 | 1975-03- | IUI-1019 |
| | 16 | | | | | 08 | |
| IUI-560 | 1984-07- | instance-of | IUI-519 | IUI-1007 | UUI-22 | 1984-07- | IUI-1021 |
| | 16 | | | | | 15 | |
| IUI-560 | 1984-07- | instance-of | IUI-519 | IUI-1010 | UUI-23 | 1984-07- | IUI-1023 |
| | 16 | | | | | 15 | |

| IUI_{d} | IUI_{A} | t_{d} | E | C | S | D-key |
|---|---|---|---|---|---|---|
| IUI-560 | IUI-1017 | 1984-07-16 | I | CR | | IUI-1018 |
| IUI-560 | IUI-1019 | 1984-07-16 | I | CR | | IUI-1020 |
| IUI-560 | IUI-1021 | 1984-07-16 | I | CE | | IUI-1022 |
| IUI-560 | IUI-1023 | 1984-07-16 | I | CE | | IUI-1024 |

9. Through the createPtoP service, the three events (birth, rape and murder) are associated with Christie Hamilton, leading to the following tables:

| IUIₐ | tₐ | r | IUIₒ | P | tᵣ | PtoP-key |
|---|---|---|---|---|---|---|
| IUI-560 | 1984-07-16 | agent-of | IUI-519 | {IUI-1001, | 1975-03-08 | IUI-1025 |
| | | | | IUI-1004} | | |
| IUI-560 | 1984-07-16 | victim-of | IUI-519 | {IUI-1001, | 1984-07-15 | IUI-1027 |
| | | | | IUI-1007} | | |
| IUI-560 | 1984-07-16 | victim-of | IUI-519 | {IUI-1001, | 1984-07-15 | IUI-1029 |
| | | | | IUI-1010} | | |

| IUI_{d} | IUI_{A} | t_{d} | E | C | S | D-key |
|---|---|---|---|---|---|---|
| IUI-560 | IUI-1025 | 1984-07-16 | I | CR | | IUI-1026 |
| IUI-560 | IUI-1027 | 1984-07-16 | I | CE | | IUI-1028 |
| IUI-560 | IUI-1029 | 1984-07-16 | I | CE | | IUI-1030 |

Sequence 3: Stan Ruffner's Imprisonment is Registered

In ways similar as in Sequence 2, the data for Stan Ruffner are added. Several tuples are added, of which only the following, the assignment of IUI-2001 to Stan Ruffner are relevant for the purposes of our example to demonstrate the error-correction logic:

| IUIₚ | IUIₐ | tₐₚ | A-key |
|---|---|---|---|
| IUI-2001 | IUI-560 | 1984-08-20 | IUI-2002 |

| IUI_{d} | IUI_{A} | t_{d} | E | C | S | D-key |
|---|---|---|---|---|---|---|
| IUI-560 | IUI-2002 | 1984-08-20 | I | CR | | IUI-2003 |

Sequence 4: Asserting Kirk Peeters as the Murderer of Christie Hamilton

In ways similar as before, a series of tuples are added, of which the following are relevant for the example:

The assignment of a IUI to Kirk Peeters:

| IUIₚ | IUIₐ | tₐₚ | A-key |
|---|---|---|---|
| IUI-3001 | IUI-560 | 1984-11-23 | IUI-3002 |

| IUI_{d} | IUI_{A} | t_{d} | E | C | S | D-key |
|---|---|---|---|---|---|---|
| IUI-560 | IUI-3002 | 1984-11-23 | I | CR | | IUI-3003 |

and the assertion that Kirk Peeters is the rapist and murderer of Christie Hamilton:

| IUIₐ | tₐ | r | IUIₒ | P | tᵣ | PtoP-key |
|---|---|---|---|---|---|---|
| IUI-560 | 1984-11-23 | agent-of | IUI-519 | {IUI-3001, | 1984-07-15 | IUI-3004 |
| | | | | IUI-1007} | | |
| IUI-560 | 1984-11-23 | agent-of | IUI-519 | {IUI-3001, | 1984-07-15 | IUI-3006 |
| | | | | IUI-1010} | | |

| IUI_{d} | IUI_{A} | t_{d} | E | C | S | D-key |
|---|---|---|---|---|---|---|
| IUI-560 | IUI-3004 | 1984-11-23 | I | CB | | IUI-3005 |
| IUI-560 | IUI-3006 | 1984-11-23 | I | CB | | IUI-3007 |

Sequence 5: Asserting Ruffner as the Rapist and Murderer of Hamilton

It is only at the time that it becomes known that Ruffner is Hamilton's murderer and not Peeters, that it is known that there are mistakes in the referent tracking system. The mistakes, in this particular case, are in the PtoP-tuples with the IUIs IUI-3004 and IUI-3006. The mistakes are corrected through the following steps:
1. Two PtoP-tuples are added asserting Ruffner as the killer and rapist of Hamilton (there are no A-tuples to be added here since all entities are already represented in the system; only some of the configurations need to be modified):

| IUIₐ | tₐ | r | IUIₒ | P | tᵣ | PtoP-key |
|---|---|---|---|---|---|---|
| IUI-560 | 2003-09-19 | agent-of | IUI-519 | {IUI-2001, | 1984-07-15 | IUI-6001 |
| | | | | IUI-1007} | | |
| IUI-560 | 2003-09-19 | agent-of | IUI-519 | {IUI-2001, | 1984-07-15 | IUI-6003 |
| | | | | IUI-1010} | | |

2. The corresponding D-tuples are added:

| IUI_{d} | IUI_{A} | t_{d} | E | C | S | D-key |
|---|---|---|---|---|---|---|
| IUI-560 | IUI-6001 | 2003-09-19 | I | CB | | IUI-6002 |
| IUI-560 | IUI-6003 | 2003-09-19 | I | CB | | IUI-6004 |

3. New D-tuples for the erroneous PtoP-tuples with IUI-3004 and IUI-3006 are added:

| IUI_{d} | IUI_{A} | t_{d} | E | C | S | D-key |
|---|---|---|---|---|---|---|
| IUI-560 | IUI-3004 | 2003-09-19 | P1 | CB | IUI-6001 | IUI-6005 |
| IUI-560 | IUI-3006 | 2003-09-19 | P1 | CB | IUI-6003 | IUI-6006 |

These tuples indicate formally:
(1) That the tuples with IUI-3004 and IUI-3006 are ‘retired’ as indicated by the appearance of another value than ‘I’ in the E-slot;
(2) That the retirement was achieved on Sep. 19, 2003 as indicated in the td slot;
(3) That the type of mistake is ‘P1’, which indicates a not existing configuration;
(4) That the reason for the change is a change in belief about what was the case, as indicated by ‘CB’ in the C-slot;
(5) That the retired tuples are respectively replaced by the tuples with IUIs IUI-6001 and IUI-6003.

Continuing with the example scenario, further, provided below is Table 7 that depicts some relevant particulars and their associated UIUs in the Peeter's case. Relevant tuples not listed in Table 7 include the A-tuples representing the assignment of the IUIs to the corresponding first order particulars, and the D-tuples that go along with them.

TABLE 7
Some relevant particulars and their associated IUIs
in the Bloodsworth case.

| | | | |
|---|---|---|---|
| IUI-1: | Christie Hamilton | IUI-2: | Christie Hamilton's rape |
| IUI-3: | Composite sketch of | IUI-4: | The August 1984 rape |
| | Hamilton's rapist | | |
| IUI-5: | Stan Ruffner | IUI-6: | Kirk Peeters |
| IUI-7: | the PtoP-tuple | IUI-8: | the PtoP-tuple representing |
| | representing that | | that IUI-6 resembles IUI-3 |
| | IUI-5 committed IUI-4 | | |
| IUI-9: | the PtoP-tuple | IUI-10: | Portion of DNA in |
| | representing that | | Hamilton'sunderpants |
| | IUI-6 committed IUI-2 | | |
| IUI-11: | Portion of Peeter's DNA | IUI-12: | Portion of Ruffner's DNA |
| IUI-13: | the PtoP-tuple | IUI-14: | the PtoP-tuple representing |
| | representing that IUI-11 | | that IUI-5 committed IUI-2 |
| | is dissimilar to IUI-10 | | |

Moreover, Table 8 below displays chronologically some of the D- and A-tuples—ignoring their authors—that would result from tracking the particulars. It provides a view into how the RTS changes over time, and how the error correction mechanism goes hand in hand with the representation of changes in reality, the understanding thereof, and changes of relevance. The correction introduced here is the insertion of the D-tuple to which IUI-109 is assigned: this tuple retires PtoP-tuple IUI-9 which included a Px type of mistake.

TABLE 8
Some of the D- and A-tuples - ignoring their authors - that would
result from tracking the particulars listed in Table 7

| Tuple | Tuple | |
|---|---|---|
| Type | IUI | Tuple |
| A | IUI-101 | <IUI-1, —, 1975> |
| D | IUI-102 | <—, IUI-101, July 1984, I, ΔRv, { }> |
| A | IUI-103 | <IUI-2, —, July 1984> |
| D | IUI-104 | <—, IUI-103, July 1984, I, ΔE, { }> |
| A | IUI-105 | <IUI-3, —, August 1984> |
| D | IUI-106 | <—, IUI-105, August 1984, I, ΔE, { }> |
| A | IUI-107 | <IUI-6, —, 1961> |
| D | IUI-108 | <—, IUI-107, 1985, I, ΔB, { }> |
| D | IUI-109 | <—, IUI-9, 1993, Px, ΔB, { }> |
| D | IUI-110 | <—, IUI-14, September 2003, I, ΔB, { }> |

Described in detail above is a capability for unambiguously tracking a portion of reality over time. The tracking is performed by a referent tracking system that can be networked and can communicate with traditional information systems. Errors in the referent tracking system (e.g., in the information stored therein) are detected and corrected. Information of the referent tracking system can be stored, displayed, printed, etc., and there are many uses for the information, including in the health field, criminal investigations, intelligence, etc.

Additional details regarding referent tracking are described in the following articles, each of which is hereby incorporated herein by reference in its entirety:
Smith B, Ceusters W, Klagges B, Koehler J, Kumar A, Lomax J, Mungall C, Neuhaus F, Rector A, Rosse C. Relations in biomedical ontologies, Genome Biology 2005, 6:R46;
Smith B, Ceusters W. An Ontology-Based Methodology for the Migration of Biomedical Terminologies to Electronic Health Records. AMIA 2005, Oct. 22-26, Washington D.C.;:669-673;
Smith B, Ceusters W. Ontology as the Core Discipline of Biomedical Informatics: Legacies of the Past and Recommendations for the Future Direction of Research, forthcoming in Gordana Dodig Crnkovic and Susan Stuart (eds.) Computing, Philosophy, And Cognitive Science, Cambridge: Cambridge Scholars Press, 2006;
Smith B, Kusnierczyk W, Schober D, Ceusters W. Towards a Reference Terminology for Ontology Research and Development in the Biomedical Domain. Proceedings of KR-MED 2006, Biomedical Ontology in Action, Nov. 8, 2006, Baltimore Md., USA;
Ceusters W. Dealing with Mistakes in a Referent Tracking System. In: Hornsby KS (eds.) Proceedings of Ontology for the Intelligence Community 2007 (OIC-2007), Columbia Mass., 28-29 Nov. 2007;:5-8;
Ceusters W, Elkin P, Smith B. Negative Findings in Electronic Health Records and Biomedical Ontologies: A Realist Approach. International Journal of Medical Informatics 2007;2007:326-333;
Ceusters W, Elkin P, Smith B. Referent Tracking: The Problem of Negative Findings, Stud Health Technol Inform. 2006;124:741-6. (Presented at MIE2006);
Ceusters W, Smith B. A Realism-Based Approach to the Evolution of Biomedical Ontologies. Proceedings of AMIA 2006, Washington D.C., Nov. 11-15, 2006, pp 121-125;
Ceusters W. Towards A Realism-Based Metric for Quality Assurance in Ontology Matching. In: Bennett B, Fellbaum C. (eds.) Formal Ontology in Information Systems, IOS Press, Amsterdam, 2006;:321-332. Proceedings of FOIS-2006, Baltimore, Md., Nov. 9-11, 2006;
Ceusters W. and Smith B. Tracking Referents in Electronic Health Records. In: Engelbrecht R. et al. (eds.) Medical Informatics Europe, IOS Press, Amsterdam, 2005;:71-76;
Ceusters W, Smith B. Strategies for Referent Tracking in Electronic Health Records. J Biomed Inform. June 2006;39(3):362-78. (ePub 2005 September 9, draft, slides presented during the IMIA WG6 workshop Ontology and Biomedical Informatics, Rome, Italy, Apr. 29-May 1, 2005)
Ceusters W, Capolupo M, De Moor G, Devlies J. Introducing Realist Ontology for the Representation of Adverse Events. In: Eschenbach C, Gruninger M. (eds.) Formal Ontology in Information Systems, IOS Press, Amsterdam, 2008, available at http://org.buffalo.edu/RTU/index.html;
Ceusters W, Spackman KA, Smith B. Would SNOMED CT benefit from Realism-Based Ontology Evolution? In Teich J M, Suermondt J, Hripcsak C. (eds.), American Medical Informatics Association 2007 Annual Symposium Proceedings, Biomedical and Health Informatics: From Foundations to Applications to Policy, Chicago Ill., 2007;:105-109;
Ceusters W, Smith B. Referent Tracking and its Applications. In: Proceedings of the WWW2007 Workshop i3: Identity, Identifiers, Identification. Banff, Canada, May 8, 2007, CEUR Workshop Proceedings, ISSN 1613-0073, online http://ceur-ws.org/Vol-249/submission_{—}105.pdf;
Ceusters W, Smith B. Referent Tracking for Corporate Memories. In: Rittgen P. (ed.) Handbook of Ontologies for Business Interaction. Hershey, New York and London: Information Science Reference, 2007, 34-46;
Ceusters W, Smith B. Referent Tracking for Treatment Optimisation in Schizophrenic Patients. Journal of Web Semantics 4(3) 2006:229-36; Special issue on semantic web for the life sciences;
Ceusters W, Smith B. Referent Tracking for Digital Rights Management. International Journal of Metadata, Semantics and Ontologies 2007;2(1):45-53;
Rudnicki R, Ceusters W, Manzoor S, Smith B. What Particulars are Referred to in EHR Data? A Case Study in Integrating Referent Tracking into an Electronic Health Record Application. In Teich J M, Suermondt J, Hripcsak C. (eds.), American Medical Informatics Association 2007 Annual Symposium Proceedings, Biomedical and Health Informatics: From Foundations to Applications to Policy, Chicago Ill., 2007;:630-634;
Manzoor S, Ceusters W, Rudnicki R. A Middleware Approach to Integrate Referent Tracking in EHR Systems. In Teich J M, Suermondt J, Hripcsak C. (eds.), American Medical Informatics Association 2007 Annual Symposium Proceedings, Biomedical and Health Informatics: From Foundations to Applications to Policy, Chicago Ill., 2007;:503-507; and
Manzoor S, Ceusters W, Rudnicki R. Implementation of a Referent Tracking System. International Journal of Healthcare Information Systems and Informatics 2007;2(4):41-58.

One or more aspects of the present invention can be included in an article of manufacture (e.g., one or more computer program products) having, for instance, computer usable media. The media has therein, for instance, computer readable program code means or logic (e.g., instructions, code, commands, etc.) to provide and facilitate the capabilities of the present invention. The article of manufacture can be included as a part of a computer system or sold separately.

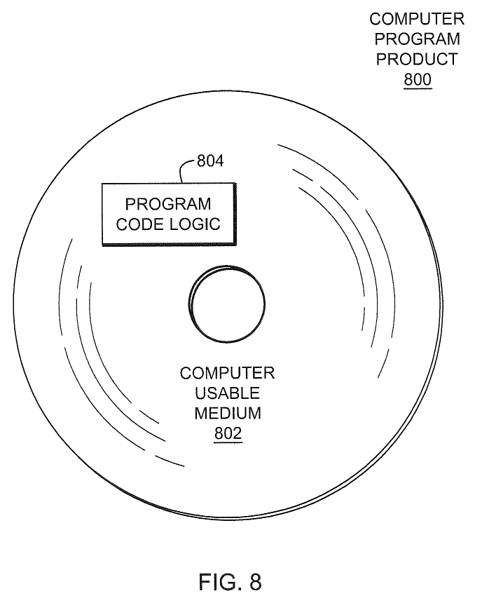

One example of an article of manufacture or a computer program product incorporating one or more aspects of the present invention is described with reference to FIG. 8. A computer program product 800 includes, for instance, one or more computer usable media 802 to store computer readable program code means or logic 804 thereon to provide and facilitate one or more aspects of the present invention. The medium can be an electronic, magnetic, optical, electromagnetic, infrared, or semiconductor system (or apparatus or device) or a propagation medium. Examples of a computer readable medium include a semiconductor or solid state memory, magnetic tape, a removable computer diskette, a random access memory (RAM), a read-only memory (ROM), a rigid magnetic disk and an optical disk. Examples of optical disks include compact disk-read only memory (CD-ROM), compact disk-read/write (CD-R/W) and DVD.

A sequence of program instructions or a logical assembly of one or more interrelated modules defined by one or more computer readable program code means or logic direct the performance of one or more aspects of the present invention.

Advantageously, a capability for performing referent tracking is provided that enables the unambiguous tracking of portions of reality over a period of time. Persistent, globally unique and singular identifiers are assigned to entities that exist or have existed in the world. Further, persistent, globally unique and singular identifiers are reserved for entities that are expected to come into existence in the world. Relationships that such entities exhibit in reality are described. To facilitate the tracking, a referent tracking system is provided for tracking entities, their relationships and descriptions thereof over time. Advantageously, the referent tracking system communicates with other referent tracking systems and traditional information systems. Data collected by means of traditional information systems are translated into a format that satisfies the principles of data-organization embodied in a referent tracking system.

Although various embodiments are described above, these are only examples. A referent tracking system can have more, less or different components than described above. Further, the components can execute on various personal computers, mainframes, distributed systems, etc. Moreover, the data may be represented in a different manner. Many other variations or additions are possible without departing from the spirit of the present invention.

Further, a data processing system suitable for storing and/or executing program code is usable that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The capabilities of one or more aspects of the present invention can be implemented in software, firmware, hardware, or some combination thereof. At least one program storage device readable by a machine embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted, or modified. All of these variations are considered a part of the claimed invention.

Although embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A method of facilitating the management of information, said method comprising:
providing in a tracking system a description of a portion of reality to be tracked, said portion of reality being a specific part of reality to be tracked by the tracking system, the description comprising:
a plurality of entities that represent items that exist or have existed in reality and that are relevant to the specific portion of reality to be tracked;
a first data type assigned to the plurality of entities;
information about one or more configurations, wherein a configuration of the one or more configurations is an association between two or more entities of the plurality of entities; and
a second data type assigned to one or more types of one or more configurations, said second data type being different from said first data type and explicitly distinguishing configurations from entities; and
using the description to unambiguously track the portion of reality over a selected time period.

2. The method of claim 1, wherein the first data type comprises a representation, said representation having a represents relationship with at least one entity of the plurality of entities, and the second data type comprises a RT-tuple, said RT-tuple having a corresponds to relationship with at least one configuration of the one or more configurations.

3. The method of claim 1, wherein an entity of the one or more entities is a universal entity or a particular entity, as indicated by a third data type or a fourth data type, respectively.

4. The method of claim 3, wherein the entity is a universal entity and the third data type comprises a universal unique identifier that denotes the universal entity.

5. The method of claim 3, wherein the entity is a particular and the fourth data type comprises an instance unique identifier that denotes the particular, the instance unique identifier is a persistent unique identifier for that particular.

6. The method of claim 3, wherein the entity is a particular, and wherein one or more data types indicate if the particular is a non-referring particular or an information bearer.

7. The method of claim 1, further comprising:
detecting an error in the description of the portion of reality, wherein the description comprises data that actually represents the portion of reality including entities and configurations, and relationships among the data; and
correcting the error.

8. The method of claim 7, wherein the correcting comprises providing a new tuple that includes corrected information.

9. The method of claim 8, wherein the correcting further comprises:
assigning a value to the error, the value corresponding to the type of error;
and
adding a meta data tuple with the assigned value, the meta data tuple being added corresponding to a tuple that is in error, wherein the tuple identifies a particular entity or configuration of the portion of reality.

10. The method of claim 1, further comprising providing an information system with the ability to use the tracking system.

11. The method of claim 10, wherein the providing comprises using a middleware component to automatically identify one or more particulars of the portion of reality and to call one or more services of the tracking system to annotate the identified one or more particulars with one or more identifiers.

12. The method of claim 1, wherein the tracking system is coupled to another tracking system via a network to enable data sharing.

13. A tracking system to facilitate the management of information, said tracking system comprising:
a data store to store a description of a portion of reality to be tracked by the tracking system, said portion of reality being a specific part of reality to be tracked by the tracking system, the description comprising:
a plurality of entities that represent items that exist or have existed in reality and that are relevant to the specific portion of reality to be tracked;
a first data type assigned to the plurality of entities;
information about one or more configurations, wherein a configuration of the one or more configurations is an association between two or more entities of the plurality of entities; and
a second data type assigned to one or more types of one or more configurations, said second data type being different from said first data type and explicitly distinguishing configurations from entities; and
at least one computing unit to use the description to unambiguously track the portion of reality over a selected time period.

14. The tracking system of claim 13, further comprising:
at least one computing unit to detect an error in the description of the portion of reality, wherein the description comprises data that actually represents the portion of reality including entities and configurations, and relationships among the data; and
at least one computing unit to correct the error.

15. The tracking system of claim 13, wherein the tracking system is coupled to an information system to enable the information system to use the tracking system.

16. The tracking system of claim 13, wherein the tracking system is coupled to another tracking system via a network to enable data sharing.

17. An article of manufacture comprising:
at least one computer usable medium having computer readable program code logic to facilitate the management of information, said computer readable program code logic when executing performing the following:
providing in a tracking system a description of a portion of reality to be tracked, said portion of reality being a specific part of reality to be tracked by the tracking system, the description comprising:
a plurality of entities that represent items that exist or have existed in reality and that are relevant to the specific portion of reality to be tracked;
a first data type assigned to the plurality of entities;
information about one or more configurations, wherein a configuration of the one or more configurations is an association between two or more entities of the plurality of entities; and
a second data type assigned to one or more types of one or more configurations, said second data type being different from said first data type and explicitly distinguishing configurations from entities; and
using the description to unambiguously track the portion of reality over a selected time period.

18. The article of manufacture of claim 17, further comprising:
detecting an error in the description of the portion of reality, wherein the description comprises data that actually represents the portion of reality including entities and configurations, and relationships among the data; and
correcting the error.

19. The article of manufacture of claim 17, further comprising providing an information system with the ability to use the tracking system.

20. The article of manufacture of claim 17, wherein the tracking system is coupled to another tracking system via a network to enable data sharing.
